(19) United States
(12) Patent Application Publication
(10) Pub. No.: US 2026/0260197 A1
(43) Pub. Date: Sep. 3, 2026

(54) SERVER DEVICE, INFORMATION PROCESSING METHOD, AND NON-TRANSITORY STORAGE MEDIUM

(71) Applicant: TOYOTA JIDOSHA KABUSHIKI KAISHA, Aichi-ken (JP)

(72) Inventors: Iwao NITTA, Nagoya-shi, Aichi-ken (JP); Teruyoshi FUJIWARA, Toyota-shi, Aichi-ken (JP); Ryota SUZUKI, Ikeda-shi, Osaka (JP)

(21) Appl. No.: 19/158,042

(22) PCT Filed: Feb. 21, 2024
(86) PCT No.: PCT/IB2024/051671

§ 371 Date: Aug. 20, 2025

(30) Foreign Application Priority Data
Mar. 1, 2023 (JP) 2023-031386

(51) Int. Cl. G06Q 10/0633; G06Q 10/30

(52) U.S. Cl. CPC G06Q 10/0633; G06Q 10/30

(57) ABSTRACT

A server includes: a memory, including dedicated storage areas, and configured to store pieces of product information of the companies, the supply chain including an upstream company and a downstream company; and one or more processor configured to execute: issuing, to the upstream company, a key indicating writing authority for the dedicated storage area of the downstream company; receiving designation of the downstream company from the upstream company, the designation being designation for permitting to make access to pieces of first product information on upstream products; writing the pieces of first product information in the dedicated storage area of the downstream company by using the key issued from the downstream company; receiving, from the account of the downstream company, a linking request including selection of first product information to be linked to second product information on a downstream product; and generating linking information indicating a relationship of linking.

### BACKGROUND OF THE INVENTION

### 1. Field of the Invention

The present invention relates to a server device, an information processing method, and a non-transitory storage medium.

### 2. Description of Related Art

There is known a system in which information is shared among a plurality of companies constituting a supply chain. For example, Japanese Unexamined Patent Application Publication No. 2004-171146 (JP 2004-171146 A) discloses a system in which product information is shared between adjacent suppliers.

### SUMMARY OF THE INVENTION

The present disclosure provides a server device, an information processing method, and a non-transitory storage medium to collect information on a supply chain.

A server device according to a first aspect of the present disclosure includes: a memory device including dedicated storage areas associated with companies, and configured to store, for each of the companies in a supply chain, pieces of product information on products of the companies by storing the pieces of product information of the companies in the associated dedicated storage areas, the supply chain including an upstream company and a downstream company defined between companies in a pair of adjacent tiers; and a control unit configured to execute, between the companies in the pair of adjacent tiers: issuing, to the upstream company, a key indicating writing authority for the dedicated storage area of the downstream company in response to a request from an account of the downstream company; receiving designation of the downstream company from an account of the upstream company, the designation being designation for permitting to make access to pieces of first product information on upstream products of the upstream company; writing, in response to permission for the access, the pieces of first product information in the dedicated storage area of the designated downstream company by using the key issued from the designated downstream company; receiving, from the account of the downstream company, a linking request including selection of first product information to be linked to second product information on a downstream product of the downstream company from among the pieces of first product information written in the dedicated storage area of the downstream company; and generating, in response to the received linking request, linking information indicating a relationship of linking designated by the linking request.

An information processing method according to a second aspect of the present disclosure is executed by a server device including a memory device configured to store, for individual companies in a supply chain, pieces of product information on products of the companies, and a control unit. The information processing method includes: between companies in a pair of adjacent tiers, issuing, to an upstream company, a key indicating writing authority for a dedicated storage area of a downstream company in response to a request from an account of the downstream company, the supply chain including the upstream company and the downstream company defined between the companies in the pair of adjacent tiers, the memory device including dedicated storage areas associated with the companies, the pieces of product information of the companies being stored in the associated dedicated storage areas; receiving designation of the downstream company, from an account of the upstream company, the designation being designation for permitting to make access to pieces of first product information on upstream products of the upstream company; writing, in response to permission for the access, the pieces of first product information in the dedicated storage area of the designated downstream company by using the key issued from the designated downstream company; receiving, from the account of the downstream company, a linking request including selection of first product information to be linked to second product information on a downstream product of the downstream company from among the pieces of first product information written in the dedicated storage area of the downstream company; and generating, in response to the received linking request, linking information indicating a relationship of linking designated by the linking request.

A non-transitory storage medium according to a third aspect of the present disclosure stores instructions that are executable by one or more processors in a target company that is configured to communicate with a server device and that cause the one or more processors to perform functions including: issuing, to an upstream company for the target company, a first key indicating writing authority for a dedicated storage area of the target company assuming that the target company serves as a downstream company, or transmitting, to the server device, a request to issue the first key to the upstream company for the target company, the server device including a memory device configured to store, for individual companies in a supply chain, pieces of product information on products of the companies, the supply chain including the upstream company and the downstream company defined between companies in a pair of adjacent tiers, the memory device including dedicated storage areas associated with the companies; receiving designation of the downstream company for the target company that is permitted to make access to pieces of first product information on first target products of the target company assuming that the target company serves as the upstream company; and writing, in response to reception of the designation, the pieces of first product information in the dedicated storage area of the designated downstream company by using a second key issued from the designated downstream company, or causing the server device to write the pieces of first product information in the dedicated storage area of the designated downstream company.

Another aspect relates to a program for causing a computer to execute the above method, or a non-transitory computer-readable storage medium storing the program.

According to the present disclosure, it is possible to collect the information on the supply chain.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 illustrates a supply chain according to a first embodiment;

FIG. 2 illustrates relationships among products supplied by the supply chain;

FIG. 3 shows an outline of a process to be performed between company terminals and a server device;

FIG. 4 is a hardware configuration diagram of the server device according to the first embodiment;

FIG. 5 is a hardware configuration diagram of the company terminal according to the first embodiment;

FIG. 6 is a software configuration diagram of the server device according to the first embodiment;

FIG. 7 is a software configuration diagram of the company terminal according to the first embodiment;

FIG. 8 shows an example of product information generated by a product information generating unit;

FIG. 9A shows an example of a screen output by an authority setting unit;

FIG. 9B shows an example of permission information generated by the authority setting unit based on input information;

FIG. 10 shows an example of a user interface including a list of products that are linking destination candidates;

FIG. 11 shows a flow of a process to be executed by the server device;

FIG. 12 illustrates a plurality of linked pieces of product information;

FIG. 13A illustrates a product tree and an amount of carbon dioxide emitted in each process;

FIG. 13B illustrates a method for transferring an integration result;

FIG. 14 shows an example of a screen in which the product tree is output as an image;

FIG. 15 shows an example of the product tree in a case where products without access authority are hidden;

FIG. 16 is a sequence diagram illustrating a process to be performed by the server device and the company terminals in second and third phases;

FIG. 17 is a sequence diagram illustrating a process to be performed by the server device and the company terminal in a fourth phase; and

FIG. 18 is a flowchart of a key issuing process in a second embodiment.

### DETAILED DESCRIPTION OF EMBODIMENTS

In recent years, there has been a demand to trace the amounts of greenhouse gases emitted when manufacturing products such as automobiles and batteries, that is, to trace a carbon footprint.

It is assumed that a product is supplied by a supply chain including a plurality of companies. In one example, at least some companies (intermediate suppliers) in the supply chain may receive components from one or more upstream companies, produce in-house products by using the received components, and deliver the produced in-house products to companies in the next step (downstream companies). Most upstream companies may directly produce in-house products and deliver the produced in-house products to companies in the next step. Some companies in the supply chain may directly deliver, to different companies, products received from other companies (i.e., participate in distribution). A plurality of companies repeats this process, and a final product is obtained in the final step.

In a case of automotive product acquisition, the supply chain may be constituted by an original equipment manufacturer (OEM) and a plurality of suppliers. The OEM may be a company that assembles a final product (most downstream company), and the supplier may be a company that supplies components, materials, assemblies, etc. for producing the product. The companies in the supply chain may be determined based on the product.

In the following description, the components etc. produced by the suppliers will be referred to as “products”, and the product obtained finally will be referred to as “final product”. In one example, the final product may be supplied to a consumer. The suppliers and the OEM in the supply chain will be referred to simply as “companies”. A plurality of hierarchical levels of the supply chain will be referred to as “tiers”.

For example, in order to calculate the total amount of greenhouse gases emitted along with the manufacture of the final product in such a system, it is necessary to clarify product supply relationships among a plurality of companies. This is because it is difficult to correctly calculate the total amount of greenhouse gases emitted in a plurality of steps unless the relationships among a plurality of products constituting the final product are clear. In order to solve this problem, for example, a process for generating a tree showing supply relationships among a plurality of products constituting the final product (hereinafter referred to as “product tree”) is necessary.

Each company other than the most downstream company can be caused to provide information indicating product supply relationships with a plurality of companies. Since information such as the company's business partners, detailed information on the in-house products, and material suppliers is highly confidential, it is not preferable to disclose the information to all unrelated companies. That is, the existing systems have a problem of difficulty in tracing carbon footprints while maintaining confidentiality. This problem is not limited to the situation where information on the carbon footprint is collected. This problem may occur in every situation where any information on a product is collected, such as other traceability-related information (e.g., a recycling rate of a raw material or due diligence information) or other information on the product (e.g., components or identification information). A server device of the present disclosure solves such a problem.

A server device according to one aspect of the present disclosure is a server device including a storage device configured to store, for individual companies in a supply chain, pieces of product information on products of the companies, and a control unit. The supply chain includes an upstream company and a downstream company defined between companies in a pair of adjacent tiers. The storage device includes dedicated storage areas associated with the companies. The pieces of product information of the companies are stored in the associated dedicated storage areas. The control unit is configured to execute, between the companies in the pair of adjacent tiers: issuing, to the upstream company, a key indicating writing authority for the dedicated storage area of the downstream company in response to a request from an account of the downstream company; receiving, from an account of the upstream company, designation of the downstream company permitted to make access to pieces of first product information on upstream products of the upstream company; writing, in response to permission for the access, the pieces of first product information in the dedicated storage area of the designated downstream company by using the key issued from the designated downstream company; receiving, from the account of the downstream company, a linking request including selection of first product information to be linked to second product information on a downstream product of the downstream company from among the pieces of first product information written in the dedicated storage area of the downstream company; and generating, in response to the received linking request, linking information indicating a relationship of linking designated by the linking request.

In the supply chain, the company positioned on the upstream side delivers a product to the company positioned on the downstream side. The most downstream company is a company that assembles a final product (OEM). Focusing on certain hierarchical levels in the supply chain, the company positioned on the upstream side is defined as the upstream company, and the company positioned on the downstream side is defined as the downstream company. A product of the upstream company will be referred to as “upstream product”, and a product of the downstream company will be referred to as “downstream product”. The upstream product can be regarded as a product constituting (incorporated in) the downstream product. Information on the upstream product will be referred to as “first product information”, and information on the downstream product will be referred to as “second product information”.

The server device according to the present disclosure stores pieces of product information for individual companies, and performs a process for linking the pieces of product information (i.e., a process for associating the downstream product and the upstream product) based on a linking request acquired from an account of each company. The linking request is a request to link pieces of product information (i.e., upstream product information and downstream product information). The control unit generates linking information in response to the linking request and stores it in the storage device. The linking information is information indicating a linking relationship between the information on the downstream product and the information on the upstream product. By repeating this process, the server device can create a product tree associated with the final product.

The pieces of product information can be linked when the downstream company that produces the downstream product designates the upstream product to which the downstream product is linked. When there are many suppliers, a method for selecting the upstream product from a list is conceivable. However, it is not preferable from the viewpoint of information protection to list information on all the companies and all the products in the supply chain.

Therefore, the server device according to the present disclosure causes the upstream company to designate in advance the downstream company permitted to access the information on the in-house product (first product information), and discloses, to the downstream company, only the product information to which the access is permitted. The downstream company selects (or designates) product information to be linked to the in-house product from among the pieces of product information to which the access is permitted by the upstream company.

When an access permission is issued, the control unit copies the pieces of first product information stored in the dedicated storage area of the upstream company (i.e., the storage area that only the upstream company is authorized to access) to the storage area that only the downstream company is authorized to access. In order to achieve this, the control unit issues a key indicating writing authority for the dedicated storage area of the downstream company in advance to the upstream company in response to a request from the downstream company, and writes the pieces of first product information in the storage area by using the key in response to a request from the upstream company. The product information copied to the dedicated storage area of the downstream company can be referred to from the account of the downstream company. Through this process, the upstream company can invest the downstream company with the authority to access specific product information.

With the server device according to the present disclosure, it is possible to clarify the supply relationships of the products among the companies. In the server device according to the present disclosure, the product information of the upstream company is written in the dedicated storage area of the upstream company and the dedicated storage area of the designated company (typically the designated downstream company), and is not written in the dedicated storage areas of the other companies. Thus, only the upstream company and the designated company can be permitted to access the information on the in-house product, thereby securing the confidentiality of the product information. The product information of the upstream company is shared between the upstream company and the designated company by being written in the dedicated storage area of the designated company by using the key of the designated company. Thus, a storage area to be shared between the upstream company and the designated company need not be provided in order to share the product information. As a result, the storage area management is facilitated. The present disclosure does not preclude the provision of the shared storage area. In another form, a storage area to be shared between two or more companies may be provided for any purposes.

The product information stored in the server device may include traceability-related information. The traceability-related information may typically be numerical information such as an amount of greenhouse gas emission, a recycling rate of a raw material, or a score related to due diligence. Pieces of traceability-related information (numerical information) collected from the companies may be integrated by any arithmetic processing. The traceability-related information need not be limited to such formats. In another example, the traceability-related information may include document information such as a technical document related to due diligence. In this case, the integration of the pieces of traceability-related information may include collection of pieces of document information.

Based on the above, the control unit may be configured to further execute acquiring pieces of traceability-related information included in product information of one or more incorporated products included in a target product and identified from linking information related to the target product and product information of the target product, integrating the pieces of traceability-related information acquired for the one or more incorporated products and the target product, and outputting a result of the integrating.

For any target product (typically a final product but may be any other product), the control unit acquires pieces of traceability-related information on the any target product and the incorporated product, and integrates the acquired pieces of traceability-related information. The incorporated product is one or more products included in the target product and produced on the upstream side of the target product. When the target product is a Tier 0 product, the incorporated product is a product in Tier 1 or higher, such as Tier 1 or Tier 2. The incorporation relationship may be established also within the incorporated products included in the target product as in a case of a Tier 2 product for a Tier 1 product. By integrating the pieces of traceability-related information, it is possible to trace the information on the amount of greenhouse gas emission, etc. while targeting any hierarchical level in the supply chain.

The pieces of traceability-related information may be integrated by repeating (A) a process of transferring, in a product tree to which the target product belongs as a root node, the traceability-related information of the upstream product to the downstream product between the companies in the pair of adjacent tiers in a range from most upstream products belonging to the product tree as leaf nodes to the target product, and (B) a process of integrating the transferred traceability-related information of the upstream product and the traceability-related information originating from the downstream product and acquiring a result of the integrating as the traceability-related information of the downstream product. The control unit may store the result of the integrating in the dedicated storage area of the downstream company. By repeating this, the control unit continuously executes the process of integrating the traceability-related information of the upstream product and the traceability-related information originating from the downstream product from the upstream side to the downstream side of the supply chain. Thus, the pieces of traceability-related information can be integrated in accordance with the product tree and the result of the integration of the pieces of traceability-related information for the target product can be obtained (i.e., information on the target product regarding a target traceability item can be derived).

Specific embodiments of the present disclosure will be described below with reference to the drawings. The hardware configuration, module configuration, functional configuration, and other specific configurations described in each embodiment are not intended to limit the technical scope of the disclosure to these configurations unless otherwise specified.

### First Embodiment

An information processing system according to the present embodiment provides information on products supplied by a supply chain including a plurality of companies. The information on products is typically information on traceability. The companies belonging to the supply chain may be determined as appropriate based on attributes of products etc.

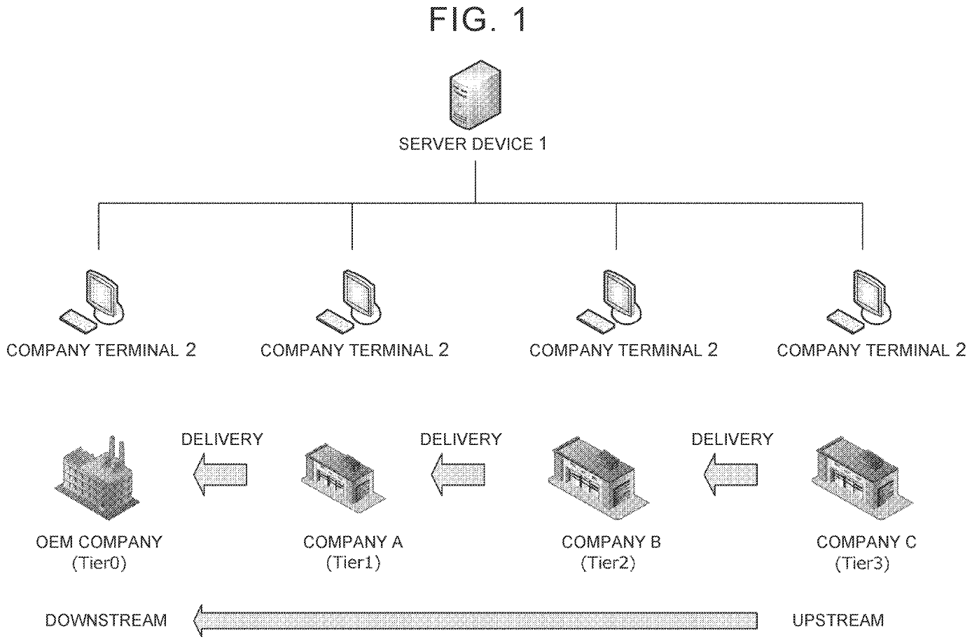

First, the structure of the supply chain will be described. FIG. 1 illustrates an example of the supply chain according to the present embodiment. In the example of FIG. 1, it is assumed that a product related to an automobile is obtained. The supply chain shown in FIG. 1 is constituted by an OEM company and a plurality of supplier companies. In the example of FIG. 1, a supply chain for manufacturing an automobile or a product related to the automobile, such as a battery, is assumed. The OEM company assembles a final product. The supplier companies (companies A to C) supply components, materials, assemblies, etc. for manufacturing the final product. The supplier companies each produce one or more products and deliver the products to a company positioned one level lower. The companies repeat this process, and the final product is obtained in the final step (i.e., the OEM company).

In the hierarchical levels of the supply chain of the present embodiment, the side that delivers a product will be referred to as “upstream side”, and the side that purchases the product and produces a new product will be referred to as “downstream side”. A company positioned on the upstream side will herein be referred to as “upstream company”, and a company positioned on the downstream side will herein be referred to as “downstream company”. A product produced by the upstream company will be referred to as “upstream product”, and a product produced by the downstream company will be referred to as “downstream product”. The downstream product incorporates the upstream product. In the present embodiment, the hierarchical levels in the supply chain will be referred to as “tiers”. Tier 0 is the lowest level (corresponding to the OEM company) at which the final product is assembled, and transition is made to the upstream side in the order of Tiers 1, 2, and 3. The downstream company may turn into an upstream company depending on the level of interest. For example, the company B positioned in Tier 2 is a downstream company in relation to Tier 3, but is an upstream company in relation to Tier 1. Thus, the definitions of the upstream company and the downstream company may vary from level to level.

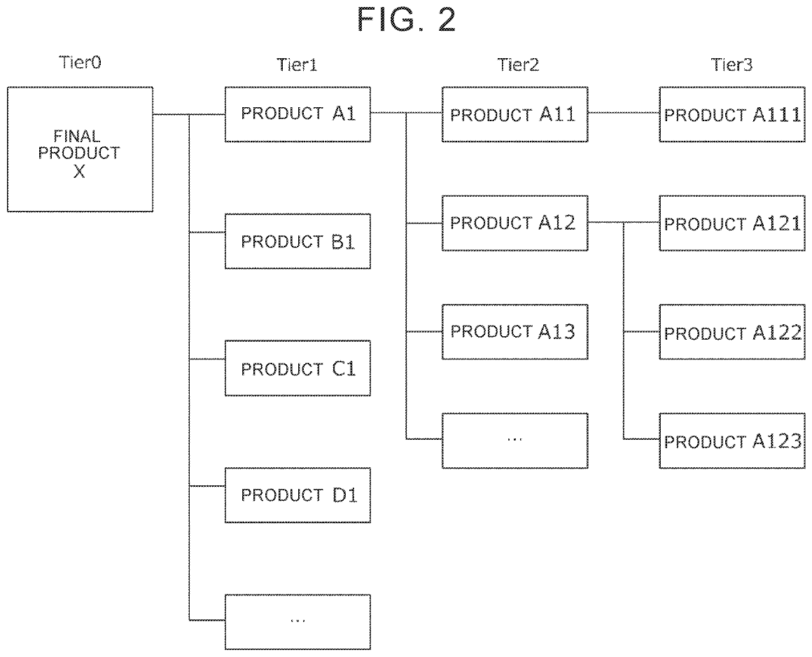

FIG. 2 illustrates relationships among products supplied by the supply chain. Supply relationships among a plurality of products constituting a final product X are represented by a tree diagram. In this example, the final product X is produced by assembling products A1, B1, C1, D1, etc. The product A1 is produced by assembling products A11, A12, A13, etc. In this way, the relationships among the products constituting the final product can be represented by a tree diagram in which the individual products serve as nodes. A tree diagram for a specific final product will hereinafter be referred to as “product tree”. In one example, the final product X is a battery to be mounted on a battery electric vehicle (BEV). In another example, the final product X may be an automobile or an automobile-related product such as an automotive assembly.

In the supply chain, the hierarchical depths of all the most upstream companies are not necessarily the same. In the example of FIG. 2, companies for products A111, A121, A122, A123, B1, C1, and D1 are the most upstream companies. Among these companies, the companies for the products B1, C1, and D1 are in Tier 1, and the companies for the products A111, A121, A122, and A123 are in Tier 3. In this case, the hierarchical depth in the entire supply chain may be counted based on the deepest most upstream company. That is, the hierarchical depth of the supply chain may be defined as the number of hierarchical levels from the most downstream company to the deepest most upstream company. In the example of FIG. 2, the hierarchical depth of the supply chain may be calculated as “4”. Therefore, when the hierarchical depth of the supply chain is specified as 3 or more and the deepest most upstream company is at the third level or higher (Tier 2 in FIG. 2), some of the most upstream companies may be at the second level (Tier 1 in FIG. 2) (the hierarchical depths of all the most upstream companies may be 3 or more). In the present embodiment, the supply chain may have three or more hierarchical levels.

As shown in FIG. 1, the information processing system according to the present embodiment includes a server device 1 and a plurality of company terminals 2.

The server device 1 according to the present embodiment collects pieces of information on products produced by the companies (hereinafter referred to as “product information”) and information for linking the pieces of product information from terminals associated with the companies (company terminals 2), and generates the product tree based on these pieces of information. The product information includes information on traceability (e.g., information on the amount of greenhouse gas emissions; hereinafter referred to as “traceability-related information”). Information on a carbon footprint etc. can be traced by tracing the product tree.

The company terminals 2 are associated with the companies constituting the supply chain. Any number of terminals may be associated with each company. Terminals associated with a target company may include a terminal of a company (e.g., an agency company) that performs operations related to the target company.

The server device 1 collects pieces of information for generating a product tree from the company terminals 2, and generates the product tree based on the collected pieces of information. The server device 1 may execute a traceability-related process (typically a process for calculating the amount of carbon dioxide emission) based on the generated product tree. The server device 1 may transmit the result of execution of the process to any company terminal 2.

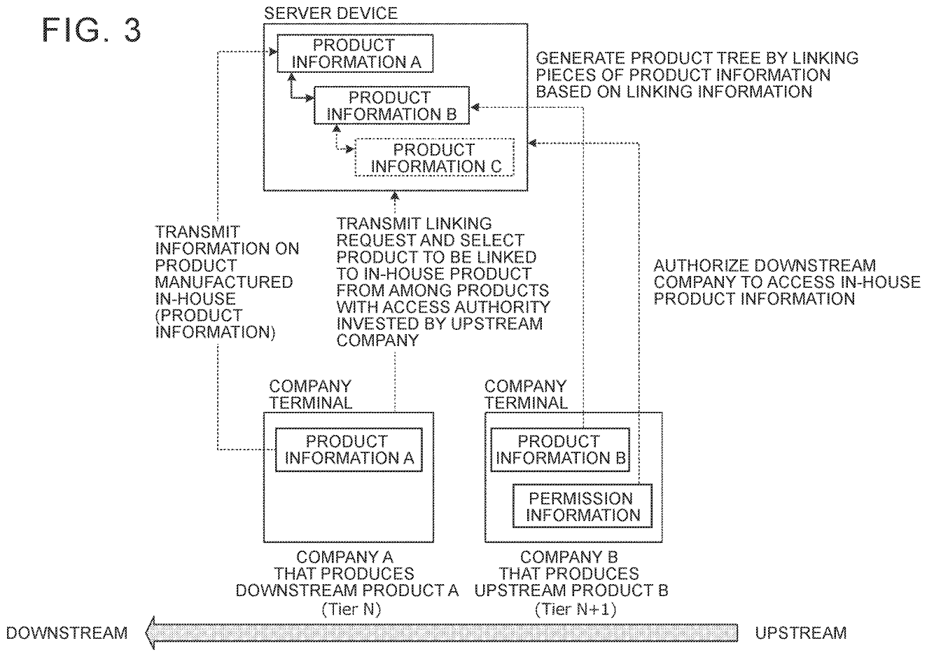

Next, an outline of a process for generating the product tree by the server device 1 will be described with reference to FIG. 3. FIG. 3 shows an outline of a process to be performed between the company terminals 2 and the server device 1. In the example of FIG. 3, it is assumed that a downstream company A and an upstream company B are present at any hierarchical levels. It is assumed that the company B produces a product B and delivers it to the company A, and the company A produces a product A by using the product B. That is, in the example of FIG. 3, the product B is a child node of the product A on the product tree.

To generate the product tree, the company terminal 2 associated with each company transmits information on a product produced by the company to the server device 1. In this example, the company terminal 2 associated with the company A transmits product information on the product A (referred to as “product information A”) to the server device 1. Similarly, the company terminal 2 associated with the company B transmits product information on the product B (referred to as “product information B”) to the server device 1. The product information of each company is stored in the server device 1.

An operation for linking the pieces of product information stored in the server device 1 is performed by the company terminal 2. In one example, a representative person of a downstream company logs into the server device 1 from the company terminal 2 by using an account of the downstream company, and selects an upstream product to be linked with a downstream product that is the in-house product. In this way, the pieces of product information are linked from the downstream product to the upstream product. The server device 1 links the pieces of product information with each other based on the selection.

If all the products in the supply chain and all the pieces of information on the products are presented as options for the selection of the product to be linked, however, the confidentiality will be lost for information on the companies constituting the supply chain and information on the products produced by the companies. Further, it may be inappropriate to disclose the entire product tree to one supplier.

Therefore, the server device 1 according to the present embodiment invests authority to access the product information of the upstream product in the downstream company in advance in response to a request from the upstream company. The server device 1 permits reference from the downstream company within a range of the invested authority.

In the example of FIG. 3, the company terminal 2 associated with the upstream company B transmits, to the server device 1, an instruction request (information) to “invest the company A with authority to access the product information B”. When a linking request is received from the company terminal 2 associated with the company A, the server device 1 provides only a list of product information that the company A is authorized to access, and prompts the company A to make selection for product information to be linked. When the company terminal 2 associated with the company A requests reference to the product tree, the server device 1 provides the company terminal 2 with the product tree in which information other than the information that the company A is authorized to access is concealed. Thus, the information on irrelevant companies and products can be concealed.

### Hardware Configurations

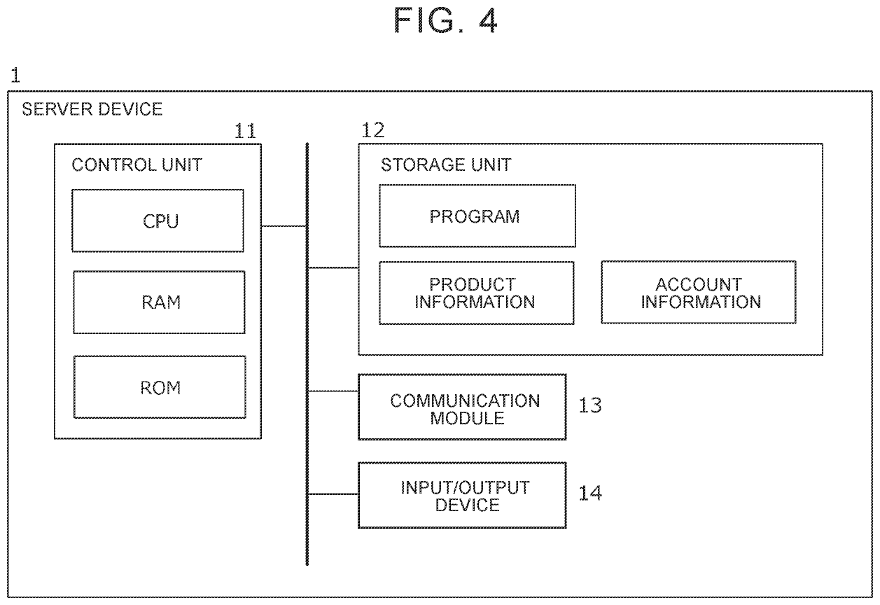

Next, the hardware configurations of the devices constituting the system will be described. FIG. 4 schematically shows an example of the hardware configuration of the server device 1 according to the present embodiment. The server device 1 is a computer including a control unit 11, a storage unit 12, a communication module 13, and an input/output device 14.

The server device 1 may be a computer including a processor (e.g., a central processing unit (CPU) or a graphics processing unit (GPU)), a main storage device (e.g., a random access memory (RAM) or a read only memory (ROM)), and an auxiliary storage device (e.g., an erasable programmable read only memory (EPROM), a hard disk drive, or a removable medium). An operating system (OS), various programs, various tables, etc. are stored in the auxiliary storage device. The programs stored in the auxiliary storage device are executed such that various functions (software modules) can be implemented to meet a predetermined purpose as described later. Some or all of the functions may be implemented as hardware modules by a hardware circuit such as an application specific integrated circuit (ASIC) or a field programmable gate array (FPGA).

The control unit 11 is an arithmetic unit that implements various functions of the server device 1 by executing a predetermined program. The control unit 11 can be implemented by, for example, a hardware processor such as a CPU. The control unit 11 may include a RAM, a read only memory (ROM), a cache memory, etc.

The storage unit 12 is means for storing information, and is constituted by a storage medium such as a RAM, a magnetic disk, or a flash memory. The storage unit 12 stores programs to be executed by the control unit 11, data to be used by the programs, etc. A database is constructed in the storage unit 12 and stores pieces of product information collected from the company terminals 2 and pieces of account information related to the companies. Details will be described later.

The communication module 13 is a communication interface for connecting the server device 1 to a network. The communication module 13 may include, for example, a network interface board and a wireless communication interface for wireless communication. The server device 1 can perform data communication with other computers (e.g., the company terminals 2) via the communication module 13.

The input/output device 14 is means for receiving an input operation performed by an operator and presenting information to the operator. Specifically, the input/output device 14 includes input devices such as a mouse and a keyboard, and output devices such as a display and a speaker. The input/output device may be an integrated device such as a touch panel display.

In the specific hardware configuration of the server device 1, any component may be omitted, replaced, or added as appropriate depending on embodiments. For example, the control unit 11 may include a plurality of hardware processors. The hardware processor may be a microprocessor, an FPGA, a GPU, etc. The input/output device 14 may be omitted, or an input/output device other than the illustrated one (e.g., an optical drive) may be added. The server device 1 may be constituted by a plurality of computers. In this case, the hardware configurations of the computers may or may not agree with each other.

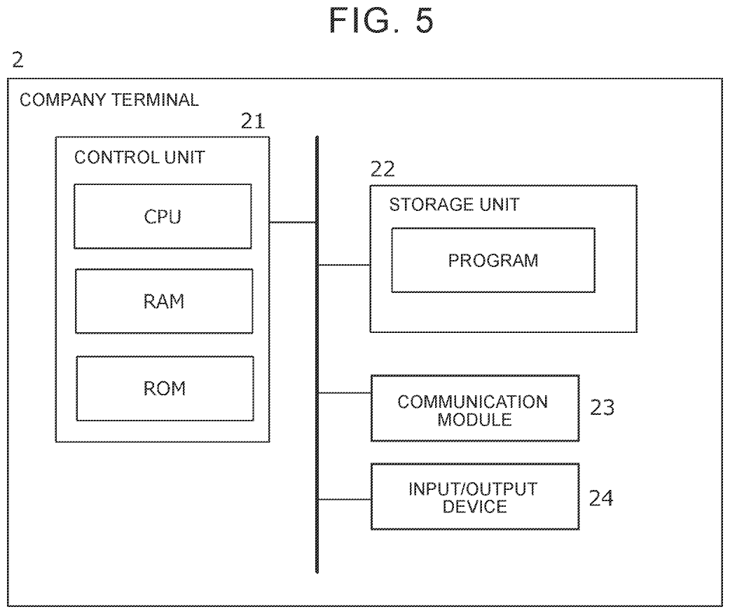

FIG. 5 schematically shows an example of the hardware configuration of the company terminal 2 according to the present embodiment. The company terminal 2 is a computer including a control unit 21, a storage unit 22, a communication module 23, and an input/output device 24.

Similarly to the server device 1, the company terminal 2 may be a computer including a processor (e.g., a CPU or a GPU), a main storage device (e.g., a RAM or a ROM), and an auxiliary storage device (e.g., an EPROM, a hard disk drive, or a removable medium). Some or all of the functions (software modules) may be implemented as hardware modules by a hardware circuit such as an ASIC or an FPGA.

The control unit 21 is an arithmetic unit that implements various functions (software modules) of the company terminal 2 by executing a predetermined program. The control unit 21 can be implemented by, for example, a hardware processor such as a CPU. The control unit 21 may include a RAM, a read only memory (ROM), a cache memory, etc.

The storage unit 22 is means for storing information, and is constituted by a storage medium such as a RAM, a magnetic disk, or a flash memory. The storage unit 22 stores programs to be executed by the control unit 21, data to be used by the programs, etc.

The communication module 23 is a communication interface for connecting the company terminal 2 to a network. The communication module 23 may include, for example, a network interface board and a wireless communication interface for wireless communication. The company terminal 2 can perform data communication with other computers (e.g., the server device 1) via the communication module 23.

The input/output device 24 is means for receiving an input operation performed by an operator and presenting information to the operator. Specifically, the input/output device 24 includes input devices such as a mouse and a keyboard, and output devices such as a display and a speaker. The input/output device may be an integrated device such as a touch panel display.

In the specific hardware configuration of the company terminal 2, any component may be omitted, replaced, or added as appropriate depending on embodiments similarly to the server device 1.

### Software Configurations

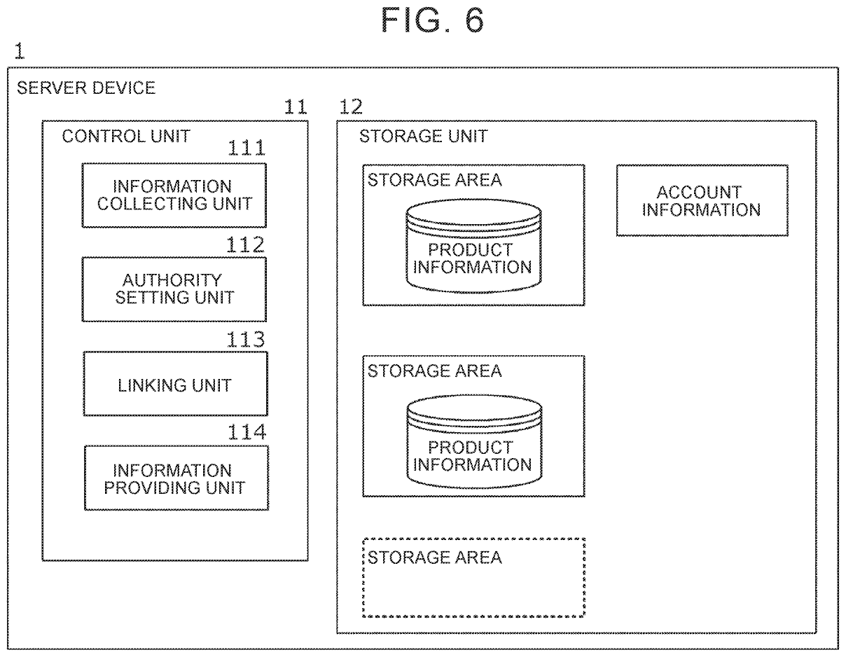

Next, the software configurations of the devices constituting the system will be described. FIG. 6 schematically shows the software configuration of the server device 1 according to the present embodiment. In the present embodiment, the control unit 11 includes four software modules that are an information collecting unit 111, an authority setting unit 112, a linking unit 113, and an information providing unit 114. The software modules may be implemented by the control unit 11 (CPU) executing programs stored in the storage unit 12. Information processing to be executed by the information collecting unit 111, the authority setting unit 112, the linking unit 113, and the information providing unit 114 is synonymous with information processing to be executed by the control unit 11.

The information collecting unit 111 executes a process for receiving product information transmitted from the company terminal 2 and storing the product information in the storage unit 12. The authority setting unit 112 receives information for setting authority to access the product information (hereinafter referred to as “permission information”) from the company terminal 2. The authority setting unit 112 executes a process for setting authority to access the product information stored in the storage unit 12 based on the received permission information. A specific method for setting authority to access specific product information for a designated company will be described later.

The linking unit 113 acquires information for linking pieces of product information from the company terminal 2 by interacting with the company terminal 2. The linking unit 113 executes a process for writing information indicating a linking relationship for the pieces of product information stored in the storage unit 12 based on the acquired information.

The information providing unit 114 executes information processing related to the product tree and outputs a result of executing the information processing. The information processing related to the product tree may include a process for performing calculation on traceability of the product tree. The output of the result of executing the information processing may include a process for providing information on the generated product tree to the company terminal 2. In one example, the information providing unit 114 generates information on the product tree and outputs the generated information on the product tree.

In the present embodiment, the storage unit 12 includes a plurality of logical storage areas. Different access authorities can be set in the storage areas, such as an area that only the company A is authorized to access, and an area that only the company B is authorized to access. The authority setting unit 112 sets the access authority by storing the product information received from the company terminal 2 in an appropriate storage area. A specific processing method will be described later.

The storage unit 12 stores account information. In the present embodiment, an operator of each company logs into the server device 1 via the company terminal 2 by using an account of the corresponding company to perform interaction between the server device 1 and the company terminal 2. The account information is information on an account associated with each company constituting the supply chain. The login using an account is an example of access to the server device 1 as a corresponding company. The method for accessing the server device 1 is not limited to such an example, and may be selected as appropriate depending on embodiments.

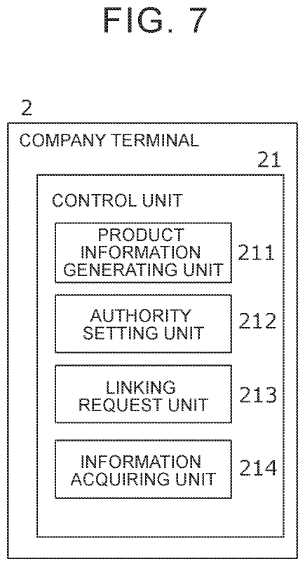

FIG. 7 schematically shows the software configuration of the company terminal 2 according to the present embodiment. In the present embodiment, the control unit 21 includes four software modules that are a product information generating unit 211, an authority setting unit 212, a linking request unit 213, and an information acquiring unit 214. The software modules may be implemented by the control unit 21 (CPU) executing programs stored in the storage unit 22. Information processing to be executed by the product information generating unit 211, the authority setting unit 212, the linking request unit 213, and the information acquiring unit 214 is synonymous with information processing to be executed by the control unit 21.

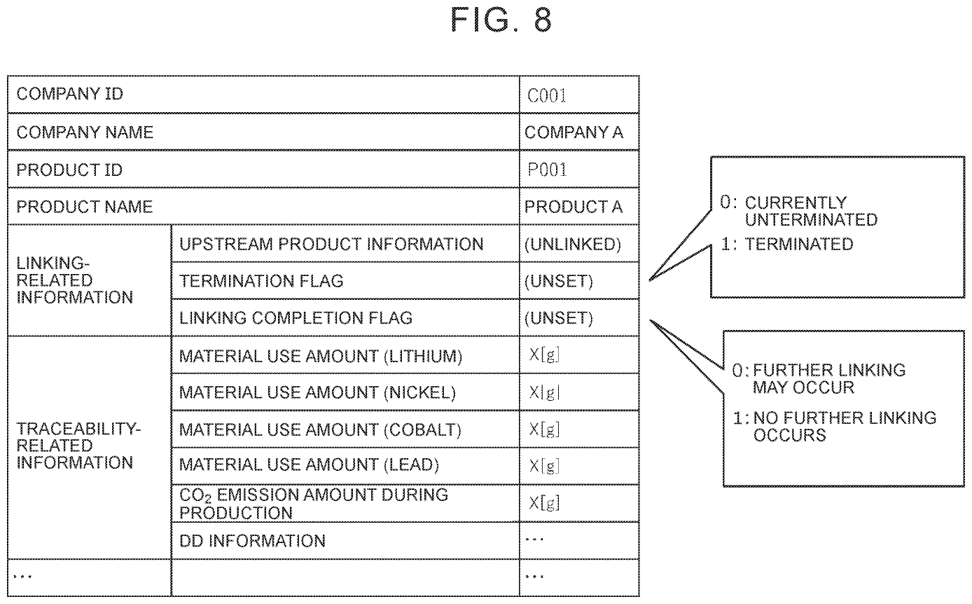

The product information generating unit 211 generates information on a product of a company associated with the company terminal 2 (product information). FIG. 8 shows an example of the product information generated by the product information generating unit 211. The product information may be input via a device operator. In the present embodiment, the product information includes fields for a company identifier (ID), a company name, a product ID, and a product name. The company ID and the company name are an identifier and a name of a company that produces a target product (i.e., the company that uses the company terminal 2). The product ID and the product name are an identifier and a name of the target product.

The product information further includes linking-related information. The linking-related information is information for identifying an upstream product linked to the target product. In the present embodiment, the linking-related information includes fields for “upstream product information”, “termination flag”, and “linking completion flag”.

The upstream product information field stores information for identifying product information associated with the upstream product linked to the target product (i.e., a product necessary for producing the target product and incorporated in the target product). The upstream product information field is used when the server device 1 links products. When the product information is generated, the target product is not basically linked to the upstream product. Therefore, the upstream product information field need not store a value indicating the upstream product.

The termination flag field stores a flag indicating whether the target product is a leaf node in the product tree, that is, a node positioned on the most upstream (terminal end) side. In the present embodiment, the plurality of company terminals 2 transmits pieces of product information. Therefore, this flag is used to determine whether an upstream product is linked to a certain product in the product tree or no more products are linked to the certain product (whether the target product is positioned on the most upstream side). That is, the termination flag field is used when the server device 1 finalizes the linking between products. When the product information is generated, the linking relationship of the target product is basically not finalized. Therefore, the termination flag field may store “0 (currently unterminated)”. To finally generate the product tree, the status of the product information of each company stored in the server device 1 is set to “linked to upstream product” or “termination flag is set to 1”.

The linking completion flag field stores a flag indicating whether the target product has been linked to the upstream product. In the present embodiment, a certain product in the product tree may be linked to a plurality of upstream products. Examples of such a case include a case where a product C is produced by using a product A and a product B as components. When the target product is positioned at an intermediate node instead of a leaf node, it is difficult to determine whether the linking is completed or another product may further be linked based only on the presence or absence of a linking destination product. Without this determination, the product tree cannot be finalized. The linking completion flag is used to identify this. That is, the linking completion flag is status information indicating whether all the linking is completed. That is, the linking completion flag field is used when the server device 1 finalizes the linking between products. When the product information is generated, the linking relationship of the target product is basically not finalized. Therefore, the linking completion flag field may store “0 (further linking may occur)”.

By referring to the termination flag for the product information positioned at the leaf node and the linking completion flag for the product information positioned at the intermediate node, it is possible to determine whether the product information is finalized. The flag stored in the termination flag field (termination flag) is an example of “termination information”.

The product information further includes traceability-related information. In one example, the traceability-related information may include amounts of materials (e.g., upstream products) used per production volume of the product, information on a recycling rate of a predetermined raw material, an amount of greenhouse gases emitted when producing the product, due diligence-related information, or a combination thereof. Examples of the predetermined raw material include lithium, nickel, cobalt, lead, and graphite. The recycling rate may be expressed directly or may be expressed indirectly, for example, by a combination of the total use amount and the amount of use of the recycled material. These values are associated with the process of producing the target product. In the example of FIG. 3, the traceability-related information in the product information A stores an amount of greenhouse gases emitted in the production activities of the product A. The traceability-related information in the product information A does not include information on the processes up to the production of the upstream product (e.g., an amount of greenhouse gases emitted until the upstream product B is produced).

The traceability-related information may be selected as appropriate depending on embodiments. In one example, the amount of greenhouse gas emissions (carbon footprint) may include emissions in scope 1, scope 2, and scope 3. Scope 1 may cover an amount of direct greenhouse gas emissions. Scope 2 may cover an amount of indirect emissions along with the use of electricity, heat, and steam supplied by other companies. Scope 3 may cover an amount of indirect emissions other than those in scope 1 and scope 2. In one example, the due diligence-related information may be technical documentation on a product containing a target raw material (e.g., cobalt, natural graphite, lithium, or nickel), indicating that responsible mineral sourcing obligations are met for the amount of the raw material contained in the product, a smelter, etc. In another example, the due diligence-related information may include a score indicating the degree to which the obligations are met.

The product information generating unit 211 acquires such information via the operator of the company terminal 2 and transmits it to the server device 1 at any timing.

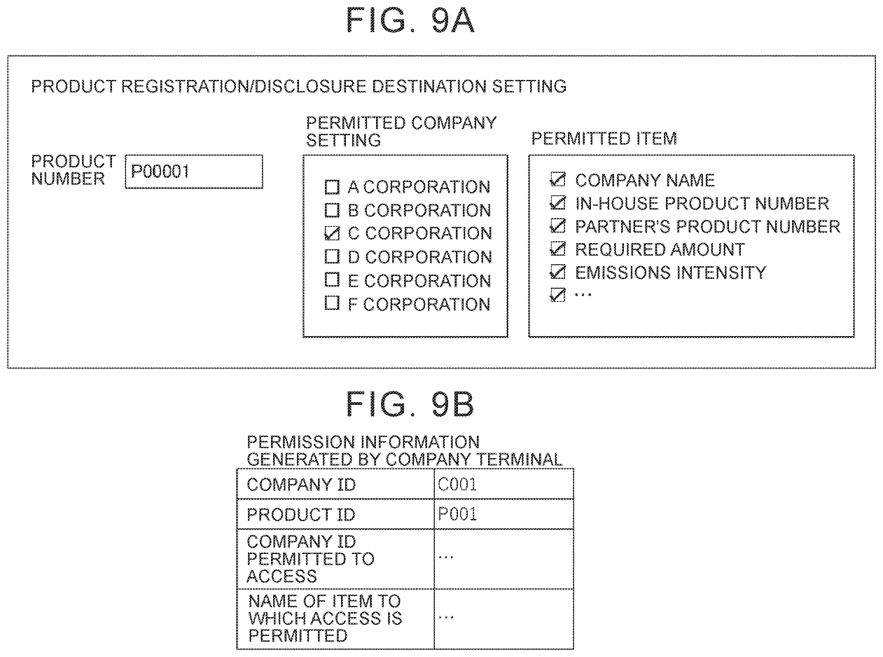

The authority setting unit 212 designates a downstream company that is permitted to access the product information transmitted from the company terminal 2 to the server device 1. FIG. 9A shows an example of a screen output by the authority setting unit 212. As in the illustration, the authority setting unit 212 receives designation of a downstream company that is permitted to access any in-house product. Except for the most downstream company and the most upstream company, a company using each company terminal 2 may be both the downstream company and the upstream company. The authority setting unit 212 operates when the company using the company terminal 2 performs work as the upstream company.

FIG. 9B shows an example of permission information generated by the authority setting unit 212 based on input information. The authority setting unit 212 transmits the permission information to the server device 1 at any timing. The access authority may be set for each piece of product information or may be set for each item in the product information (“permitted item” in the figure). Thus, partial disclosure can be achieved such that the existence of the product is disclosed but specific information on the materials used, the amount used, etc. is not disclosed.

The list of companies presented on the screen of FIG. 9A may be a list of companies that have records of transaction with the company of interest in the past. Therefore, the server device 1 may store data on past transaction (transaction data) for each company and generate the list of companies based on the transaction data. The transaction data may include, for example, an identifier of a target product, an identifier of a company that produced the product, and a date of transaction.

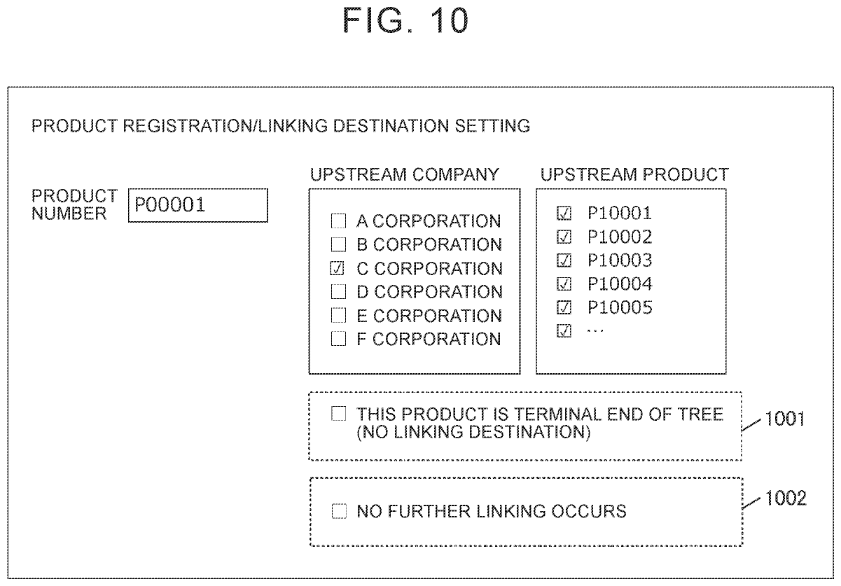

The linking request unit 213 requests the server device 1 to link the in-house product information transmitted to the server device 1 to an upstream product. The linking request unit 213 operates when the company using the company terminal 2 performs work as the downstream company. In one example, the linking request unit 213 first transmits a company ID and a product ID of the company of interest to the server device 1, and requests the server device 1 to link product information associated with the product ID. The server device 1 generates a user interface including a list of product information (i.e., linking destination candidates) that the target company is permitted to access, and provides the generated user interface to the company terminal 2. FIG. 10 shows an example of the user interface including a list of products that the target company is permitted to access.

The list of products presented in FIG. 10 may be a list of products that have records of transaction with the company of interest in the past. The server device 1 may generate the list based further on the stored transaction data.

Subsequently, the linking request unit 213 prompts the operator to select an upstream product to be linked from the list. The linking request unit 213 transmits, to the server device 1, a pair of an identifier of a linking source product (downstream product) and an identifier of the linking destination upstream product. In response to this, the server device 1 can link the pieces of product information.

When there is no upstream product to be linked to the target product, this fact can clearly be indicated, for example, by marking a checkbox represented by reference numeral 1001 in FIG. 10. In this case, pieces of product information are not linked, and the server device 1 sets the termination flag of the corresponding product information to “1”. When there is an upstream product to be linked to the target product, that is, when the node associated with the target product is not a leaf node, the marking operation is prohibited.

When no further linking is performed for the target product, this fact can clearly be indicated by marking a checkbox represented by reference numeral 1002 in FIG. 10. In this case, the server device 1 sets the linking completion flag of the corresponding product information to “1”. When the termination flag is set to “1”, the corresponding product information is the terminal end, and is therefore excluded from the linking target. In this case, the linking completion flag may be handled in any way. In one example, the linking completion flag may be set to “1” in response to the setting of the termination flag to “1”. In another example, the linking completion flag may remain “0” and be ignored when the termination flag is set to “1”.

In this way, the linking request unit 213 issues (1) a linking request to link the target product and the upstream product or (2) a request to assign the termination flag indicating that the target product is the terminal end of the supply chain. When declaring the completion of linking, the linking request may include a request to assign the linking completion flag indicating that no further linking occurs for the target product. Thus, the server device 1 can finalize the state of the product tree.

The information acquiring unit 214 requests the server device 1 to provide the product tree and outputs the information transmitted from the server device 1.

### Details of Process

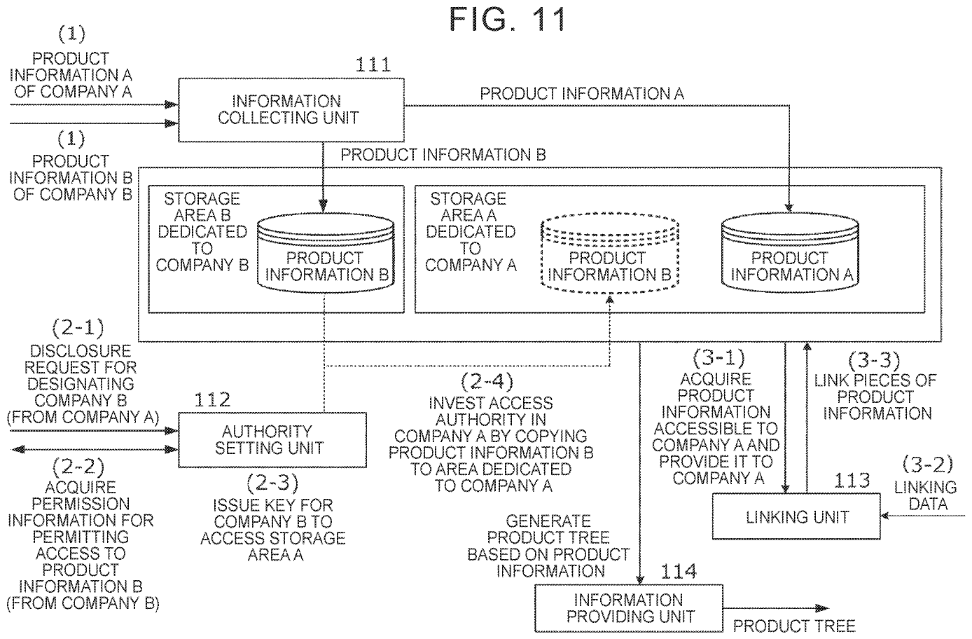

Next, details of a process to be performed by the server device 1 and the company terminal 2 will be described. FIG. 11 shows an example of a flow of a process to be executed by the server device 1 based on a request from the company terminal 2. The process to be performed by the server device 1 can roughly be divided into the following four phases.
(1) First phase for receiving product information transmitted from the company terminal 2 and storing the received product information
(2) Second phase for receiving permission information transmitted from the company terminal 2 and setting authority to access the product information based on the received permission information
(3) Third phase for linking pieces of product information by interacting with the company terminal 2
(4) Fourth phase for providing information on a product tree based on a linking result

In the example of FIG. 11, a company A is a downstream company and a company B is an upstream company. A product produced by the company A will be referred to as “product A”, and a product produced by the company B will be referred to as “product B”. Product information associated with the product A will be referred to as “product information A”, and product information associated with the product B will be referred to as “product information B”.

In the first phase, the information collecting unit 111 of the server device 1 acquires product information from the product information generating unit 211 of the company terminal 2. In the example of FIG. 11, the server device 1 acquires the product information A from the company terminal 2 associated with the company A, and acquires the product information B from the company terminal 2 associated with the company B. The information collecting unit 111 saves the product information A in a storage area that only the company A is authorized to access (hereinafter referred to as “storage area A”). The information collecting unit 111 saves the product information B in a storage area that only the company B is authorized to access (hereinafter referred to as “storage area B”). In this way, the information collecting unit 111 saves the product information transmitted from any company in a dedicated storage area that only the company is authorized to access. In the following description, a storage area that only a specific company is authorized to access will be referred to as “dedicated storage area”.

In the second phase, the authority setting unit 112 of the server device 1 interacts with a plurality of company terminals 2, and sets authorities to access pieces of product information based on interaction results. The second phase may be started in response to a request transmitted from a company to be invested with access authority (downstream company). This request is a request for the upstream company to invest authority to access the product information on the upstream product. This request will hereinafter be referred to as “disclosure request”.

The authority setting unit 112 first receives the disclosure request from the company terminal 2 used by the downstream company (“2-1” in the figure). In one example, the disclosure request may include pieces of information for identifying the downstream company (i.e., the company that has transmitted the disclosure request) and the upstream company (the company requested to invest access authority).

Next, the authority setting unit 112 requests the company terminal 2 of the upstream company designated by the disclosure request to input permission information. The company terminal 2 (authority setting unit 212) of the upstream company receives permission information input by the operator, and transmits the acquired permission information to the server device 1 (“2-2” in the figure). As shown in FIG. 9B, the permission information associates a product with a company that is permitted to access product information on this product (i.e., the permission information includes pieces of information for identifying the designated product and the company permitted to access the product).

Next, the authority setting unit 112 issues a key for accessing the storage area associated with the company that has transmitted the disclosure request. In this example, the authority setting unit 112 issues a key for accessing the storage area A allocated to the downstream company A to the account of the upstream company B (“2-3” in the figure). Then, the authority setting unit 112 uses the key issued to the account of the upstream company to copy the product information B owned by the upstream company B and stored in the storage area B to the storage area A (“2-4” in the figure).

In the example of FIG. 11, it is assumed that the authority setting unit 112 receives permission information indicating that the downstream company A is permitted to access the product information B of the upstream company. In this case, the authority setting unit 112 uses the key issued in (2-3) to copy the product information B stored in the storage area B to the storage area A that only the company A is authorized to access. Thus, the product information B is accessible to the company A. In the present embodiment, the company A is invested with the authority to access the product information B through such a process. When no access authority is set for a specific item in the product information, the item is excluded from the target of copy to the storage area A.

In this way, the server device 1 copies the product information in response to reception of the permission information from the company terminal 2 of the upstream company.

In the third phase, the linking unit 113 of the server device 1 receives a linking request from the linking request unit 213 of the company terminal 2, and links the pieces of product information based on the received linking request.

First, the linking unit 113 receives the linking request from the company terminal 2. The linking request is transmitted from the company terminal 2 of the downstream company. In the example of FIG. 11, it is assumed that the company terminal 2 of the company A transmits the linking request. The linking request includes a company ID and a product ID of a target product. The linking unit 113 acquires product information stored in the storage area accessible to the company, and generates a list of the acquired product information. In the example of FIG. 11, the company A can access the product information B (information on the product of the other company) stored in the storage area A. Therefore, the product information B can be selected as a linking destination in the company terminal 2 of the company A.

The linking request unit 213 of the company terminal 2 presents the list to an operator, and prompts the operator to select products to be linked (“3-1” in the figure). In this example, the product A and the product B are linking targets. For example, the operator inputs, via the input/output device 24, information indicating that the product B is an upstream product for the product A. The linking request unit 213 transmits data for associating the upstream product (product B) and the downstream product (product A) with each other (linking data) to the linking unit 113 (“3-2” in the figure).

As described with reference to FIG. 8, the product information includes the field related to the product to be linked (linking-related information). Based on the linking data, the linking unit 113 stores information associated with the product information B (i.e., the upstream product) in the linking-related information of the product information A, thereby linking the pieces of product information (“3-3” in the figure). For example, the linking-related information stores information indicating the linking relationship, such as an identifier of the upstream product and an identifier of the company that produces the upstream product.

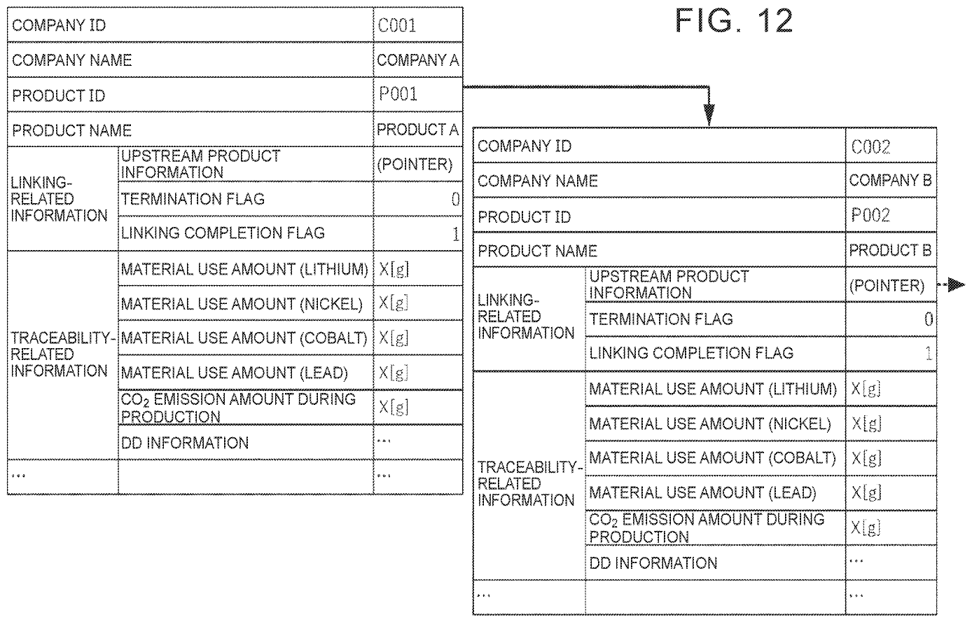

The format of the linking-related information may be changed as desired. In another example, the linking-related information may store link information such as a pointer to the linking destination product information. FIG. 12 illustrates an example in which a plurality of pieces of product information is linked by pointers. Arrows in the figure represent the pointers. The pointer indicates a storage location of information such as an address of the product information associated with the upstream product.

Through the process described above, a part of the tree structure is formed in which the product information of the downstream product is placed as a parent node and the product information of the upstream product is placed as a child node.

No further linking is performed at the terminal end of the product tree. In this case, the linking request unit 213 transmits data indicating that the product is the terminal end of the tree instead of transmitting the linking data. In the example of FIG. 10, the data indicating that the product is the terminal end of the tree is transmitted when the checkbox represented by reference numeral 1001 is marked. When the data is received, the linking unit 113 sets “1” in the termination flag field of the corresponding product information (i.e., the termination flag is set).

When it is clear that no further linking occurs for the target product, the linking request unit 213 transmits data clearly indicating this fact in the linking data. In the example of FIG. 10, data indicating that no further linking occurs for the product is transmitted when the checkbox represented by reference numeral 1002 is marked. When the data is received, the linking unit 113 sets “1” in the linking completion flag field of the corresponding product information. When the termination flag is set, both the flags may be set to “1”.

That is, the linking request unit 213 may issue one of the following requests to the server device 1 in the third phase.
(A) “Request to designate the linking destination upstream product (including a request to set the linking completion flag)”
(B) “Request to set the termination flag”
A product tree of a final product is completed when all the companies belonging to the supply chain have been linked or the termination flag has been assigned. This product tree may be formed through any process. In one example, the companies may execute the third phase indiscriminately (referred to as “shotgun method”). With this method, the processing load on the server device 1 can be reduced because there is no need to manage the execution of the third phase. In another example, the third phase may be executed sequentially from the most upstream company (referred to as “bucket brigade method”). In this case, the server device may permit linking in Tier N or setting of the termination flag after linking in Tier N−1 is completed. With this method, the completion of the product tree can be managed easily.

In the fourth phase, the information providing unit 114 of the server device 1 generates information on the product tree based on the stored pieces of product information, and outputs the information on the product tree. The generation of the information on the product tree refers to a process for generating various types of information on the products (e.g., information on traceability and an image showing the linking relationship among the products in a tree diagram) after links between nodes are formed by linking the pieces of product information. This process for generating the information on the product tree is an example of information processing on the product tree. To generate the information on the product tree, it is necessary that all the pieces of product information have been linked and the termination flags of all the leaf nodes have been set to “1”. The information providing unit 114 can appropriately generate the information when such conditions are satisfied.

As described with reference to FIG. 2, the product tree in the present embodiment is a tree diagram showing the supply relationships among the pieces of product information in the supply chain. The information providing unit 114 can generate the image showing the tree diagram based on the pieces of product information.

When generating the information on the product tree, the information providing unit 114 integrates the pieces of traceability-related information defined in the pieces of product information, and outputs a result of the integration.

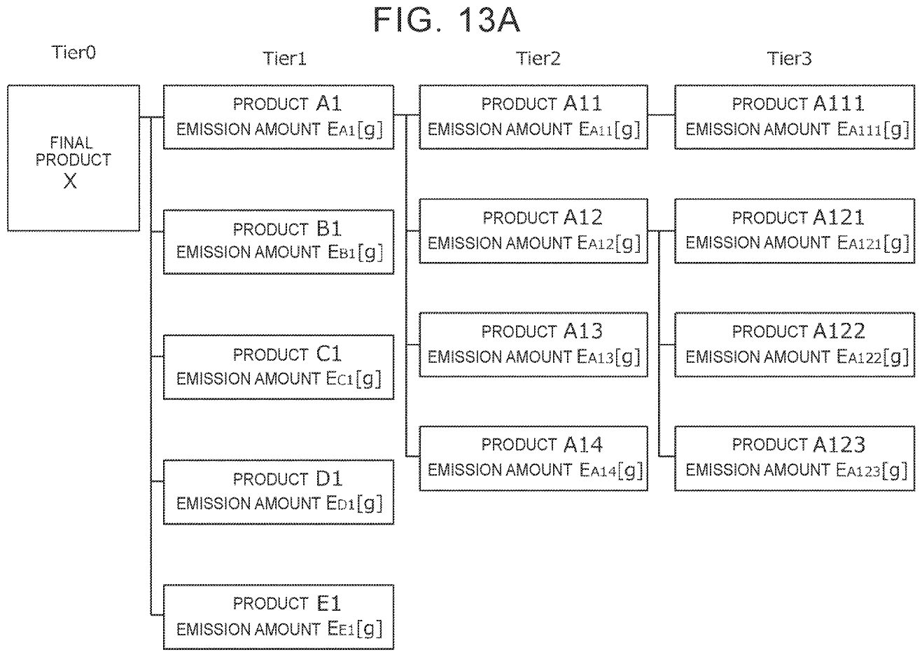

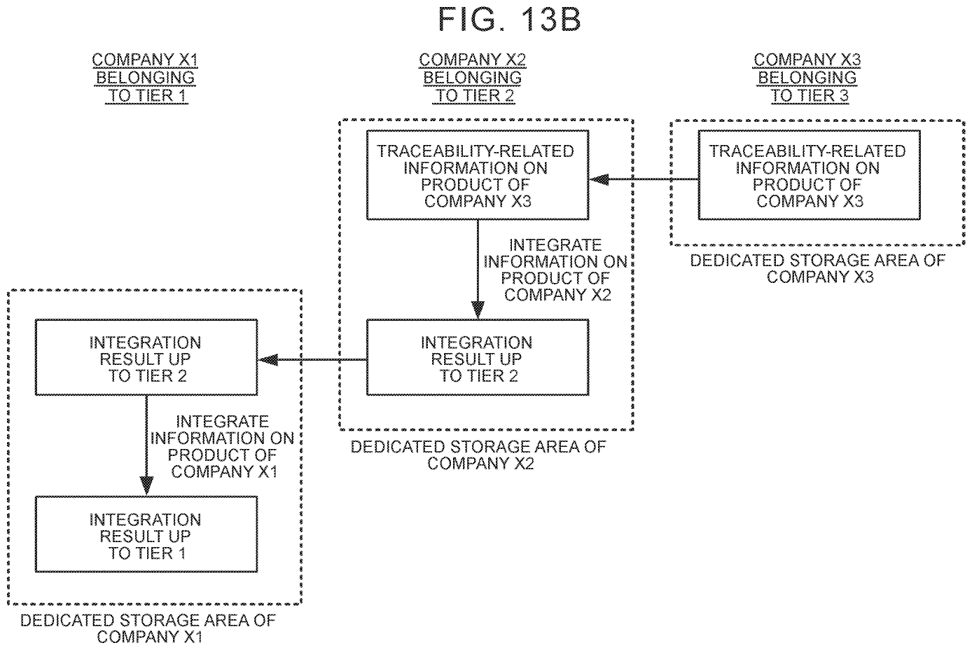

The integration of the pieces of traceability-related information will be described with reference to FIG. 13A. FIG. 13A illustrates a plurality of products constituting the final product X and the amounts of carbon dioxide (CO₂) emitted in individual processes for producing the products. For example, it is assumed that E_{A12} [g] of carbon dioxide is emitted in a process for producing the product A12 in the figure. It is also assumed that this product is composed of three upstream products A121 to A123. An upstream product included in a certain product will be referred to also as “incorporated product”. The total amount of carbon dioxide emitted until a certain target product is produced can be obtained by repeating a process of transferring the amount of CO₂ emission associated with an upstream product to a downstream product while referring to the product information between companies at two adjacent hierarchical levels from the most upstream product at the leaf node to the target product.

When the target product is A12 in the example of FIG. 13A, the total amount of carbon dioxide emitted until the product A12 is produced can be calculated by summing the amounts of CO₂ emission associated with the incorporated products (upstream products A121 to A123) and the amount of CO₂ emission associated with the product A12. That is, the integrated amount of CO₂ emission for the product A12 is as follows.

$${I}_{A 12} = {E}_{A 12} + {E}_{A 121} \times {U}_{A 121} + {E}_{A 122} \times {U}_{A 122} + {E}_{A 123} \times {U}_{A 123} [ g ]$$

In this expression, E_{A121}, E_{A122}, and E_{A123} are CO₂ emissions per unit amount when the products A121, A122, A123 are produced, respectively. Further, U_{A121}, U_{A122}, and U_{A123} are the amounts of use of the products A121, A122, A123 in the production of the product A12, respectively. This use amount is an example of the amount of material used per production volume of the product in the traceability-related information. The amount of CO₂ emission of the final product (product of the most downstream company) can be obtained by sequentially executing the above calculation from the product of the most upstream company to the final product.

The same applies to a case where the target product is the product A1. When the target product is A1, the total amount of carbon dioxide emitted in the manufacturing activities until the product A1 is produced can be calculated by integrating the amount of CO₂ emission associated with the product A1 and the amounts of CO₂ emission associated with the incorporated products A11, A12, A13, A14.

The integrated value may be stored in the storage unit 12 separately from the product information or may be included as a part of the product information. That is, the product information associated with the product A12 may hold both E_{A12} that is the emission amount in the process alone and I_{A12} that is the integrated emission amount.

Post-integration traceability-related information is reused when performing integration for a downstream product. By executing this process at each hierarchical level starting from the most upstream side, the traceability-related information (e.g., the cumulative value of the amounts of CO₂ emission) is sequentially transferred in the downstream direction. When the traceability-related information is finally transferred to the final product, the traceability-related information associated with the entire period until the final product is produced (e.g., the total amount of CO₂ emission) can be obtained.

In the present embodiment, each company can only view its dedicated storage area, and does not have authority to view dedicated storage areas of other companies. Therefore, the process of integrating the pieces of traceability-related information is executed in the dedicated storage area of each company. That is, the server device 1 refers to information in the dedicated storage area of each company, and integrates traceability-related information transferred (written) from the upstream company for each company with traceability-related information of each company. At this time, the information providing unit 114 may transfer the obtained integration result (traceability-related information of each company's product obtained through the integration) to the downstream company for each company (i.e., write it in the dedicated storage area of the downstream company).

FIG. 13B illustrates an example of a data flow when the integration result up to the company of interest is copied to the dedicated storage area of the company belonging to the tier adjacent downstream. In this example, it is assumed that a Tier 1 company X1, a Tier 2 company X2, and a Tier 3 company X3 are present in the supply chain and the company X3 is a terminal end company.

In a dedicated storage area of the company X3, product information related to a product of the company X3 is stored together with traceability-related information. The information providing unit 114 reflects the traceability-related information in the product information of the company X3 written in a dedicated storage area of the company X2. Then, the information providing unit 114 integrates the traceability-related information of the product of the company X3 written in the dedicated storage area of the company X2 and traceability-related information related to a product of the company X2, and reflects the integration result in product information of the company X2 written in a dedicated storage area of the company X1.

In this way, the information providing unit 114 may execute, sequentially from the most upstream company to the downstream side, the process of transferring (writing) the traceability-related information (integration result for companies other than the most upstream company) using the key of the downstream company and the process of integrating the pieces of traceability-related information in the dedicated storage area of each company. According to this configuration, the downstream company can refer to the result of the integration of the pieces of traceability-related information up to the upstream product of the upstream company in the dedicated storage area of the downstream company. Thus, the result of the integration of the pieces of traceability-related information can be transferred between the companies and the pieces of traceability-related information on the target product can be obtained.

In the present embodiment, the traceability-related information derived from the product of the upstream company need not be transferred to the downstream company between adjacent companies, except for the traceability-related information of the most upstream company. That is, the server device 1 need not copy traceability-related information specific to the upstream product (e.g., the amount of CO₂ emission in the production activities of the upstream product in the upstream company) to the dedicated storage area of the downstream company unless permission is given by the upstream company (e.g., on the screen of FIG. 9A). Thus, it is possible to obtain the traceability-related information (integration result) on the target product while securing the confidentiality of the traceability-related information derived from the product of each company except the most upstream company.

As described above, the server device 1 (information providing unit 114) sequentially executes the transfer process and the integration process for the traceability-related information in each piece of product information from the most upstream side to the most downstream side. Thus, the information providing unit 114 can generate information on the product tree including the result of the integration of the pieces of traceability-related information.

In the above example, the amount of carbon dioxide emission is exemplified as the integration target, but the traceability-related information that is the integration target may be a recycling rate related to a predetermined raw material, a score related to due diligence, etc. When the traceability-related information is a numerical value, the integration may be performed by numerical calculation. When the traceability-related information is non-numerical information (e.g., due diligence-related information), the integration may simply be information collection.

The traceability-related information need not be included in the product information. For example, the product information may include information indicating the location of the traceability-related information of the corresponding product (hereinafter referred to as “location information”; typically address or pointer). In this case, the integration may be collection of the location information included in the product information.

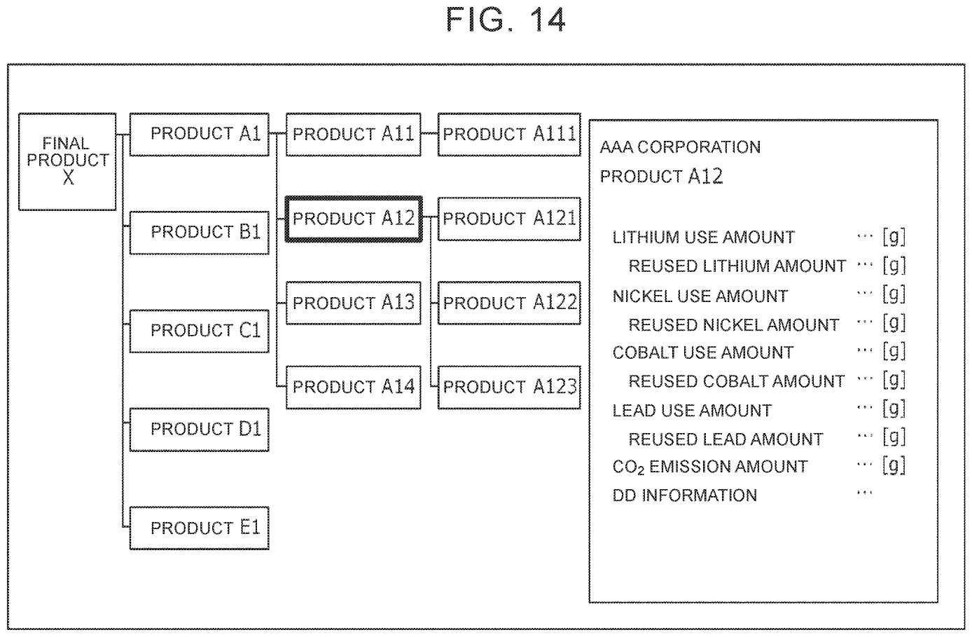

The information providing unit 114 may output the generated product tree in an image format. The information providing unit 114 may simultaneously output the traceability-related information associated with any product. FIG. 14 shows an example of a screen in which the product tree is output as an image. The illustrated screen includes an image showing a tree diagram of the supply relationships among the products constituting the final product. When any product is selected, the traceability-related information associated with the product or the result of the integration of the pieces of traceability-related information associated with the entire period until the product is produced (e.g., the total amount of carbon dioxide emission from the most upstream side) can be viewed. Such information can be output via the input/output device 14 of the server device 1 based on an operation performed by the operator of the server device 1.

The information providing unit 114 may provide the generated product tree to the company terminal 2 in response to a request from the company terminal 2 (information acquiring unit 214). It may be inappropriate to disclose the entire product tree to a specific company. Therefore, when providing the product tree to the company terminal 2 associated with a certain company, the information providing unit 114 may perform a process for hiding a range that the company is not authorized to access.

In the example of FIG. 13A, it is assumed that the information providing unit 114 receives a product tree disclosure request from the company terminal 2 associated with the company that produces the product A12. It is assumed that the company is authorized to access only the products A121, A122, A123. That is, the company cannot access product information other than those of the three products and the downstream product A1. In this case, the information providing unit 114 provides the company terminal 2 with the product tree in which pieces of information on products without access authority are hidden.

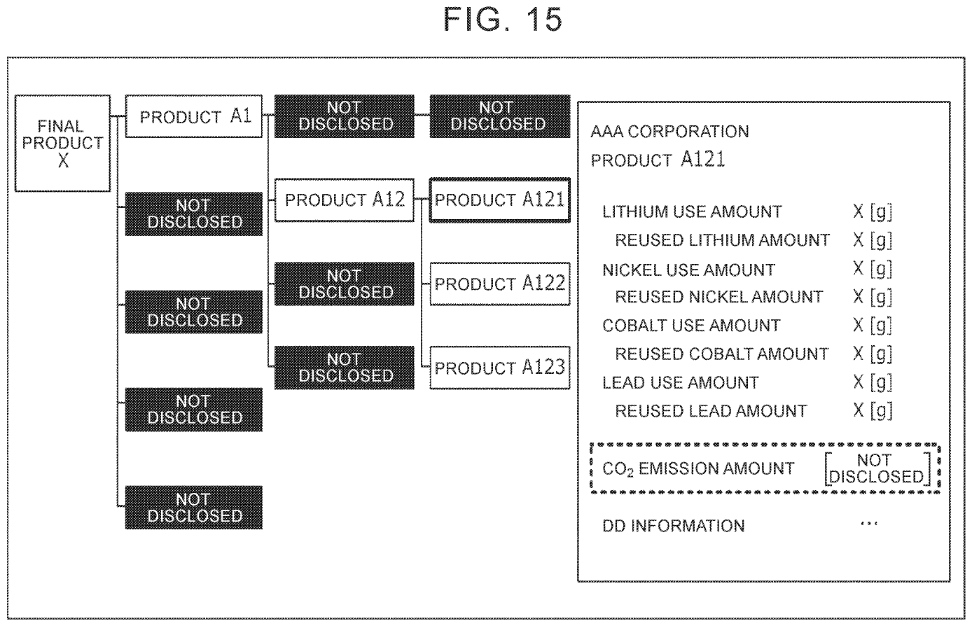

FIG. 15 shows an example of the product tree in the case where the products without access authority are hidden. In this example, the product tree is displayed with detailed information (or existence) concealed for undisclosed products. In the present embodiment, (concealed) product information that the target company is not permitted to access is not written in the dedicated storage area of the target company. Therefore, the information providing unit 114 may conceal the part of the corresponding product in the product tree in response to the fact that the product information is not written in the dedicated storage area of the target company, and provide the product tree including the concealment to the target company.

In a case where the existence of a product is disclosed but access authority is not invested only for a specific item in the corresponding product information, the concealing process may be performed only on the specific item as indicated by a dotted line in the figure. In the illustrated example, the amount of carbon dioxide emission when the product A121 is produced is hidden.

Even if the tree includes products (or items) without access authority, the pieces of traceability-related information may be integrated without being affected by this. In the illustrated example, the amount of carbon dioxide emission for the product A121 is hidden, but the process of calculating the total amount of carbon dioxide emission for the product A12 is not affected.

The concealing method is not limited to such a method. In another example, when all the pieces of product information are accessible, the information providing unit 114 may generate a product tree that is not subjected to the concealing process, and then perform the concealing process on the product tree for each company based on access authority invested in each company. Alternatively, the information providing unit 114 may generate the product tree by using authority of the corresponding company. For example, when the product tree is requested by the company A, the information providing unit 114 may generate at least a part of the product tree by using the account of the company A and extracting information from a storage area that the company A is permitted to access.

### Processing Flow

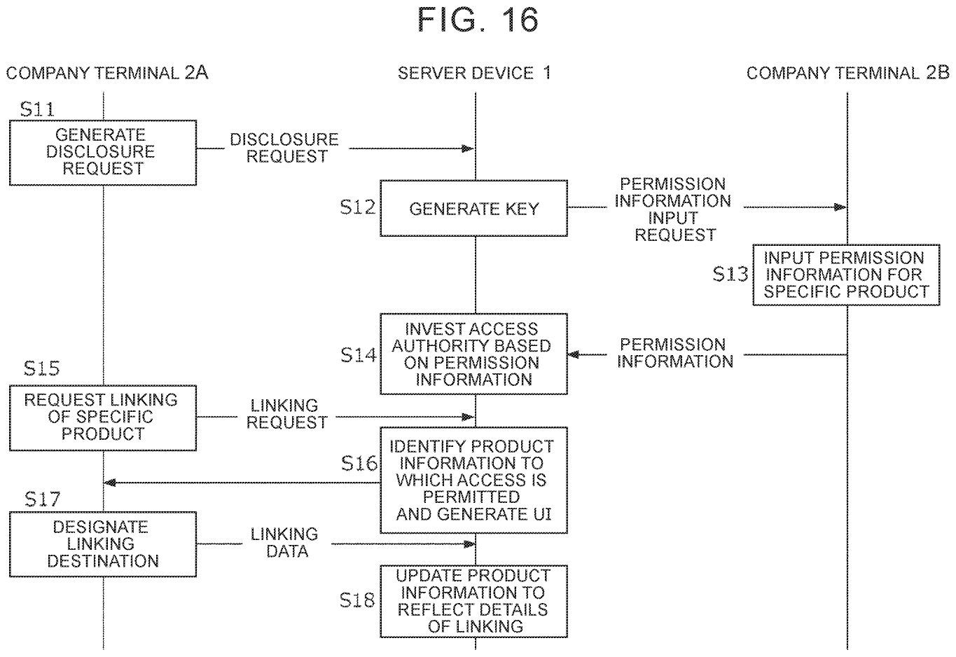

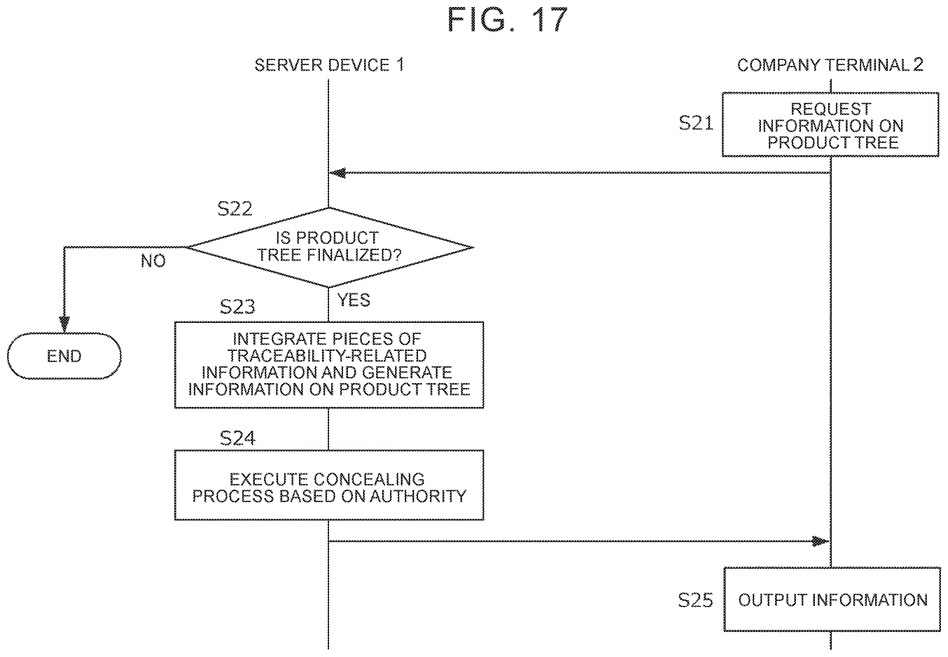

Next, a flow of a process to be executed by the server device 1 and the company terminal 2 will be described with reference to FIGS. 16 and 17. FIG. 16 is a sequence diagram corresponding to the second and third phases.

In one example, the interaction between the server device 1 and the company terminal 2 is started when the operator of each company logs into the server device 1 via the company terminal 2 by using the account of the corresponding company. In this example, it is assumed that the operator of each company logs into the server device 1 by using the company's account.

As a premise of the process, it is assumed that the server device 1 acquires pieces of product information of a plurality of companies from a plurality of company terminals 2 associated with the companies and stores the acquired pieces of product information. A company terminal used by a downstream company will be referred to as “company terminal 2A”, and a company terminal used by an upstream company will be referred to as “company terminal 2B”. The product information received by the server device 1 (information collecting unit 111) is stored in the storage unit 12. At this time, the information collecting unit 111 saves the product information in a storage area that only the company that produces the corresponding product is authorized to access (dedicated storage area).

In step S11, the company terminal 2A used by the downstream company first generates a disclosure request for requesting the upstream company to invest authority to access product information on an upstream product. The disclosure request is received by the server device 1 (authority setting unit 112). In response to the reception of the disclosure request, the authority setting unit 112 of the server device 1 generates a key for accessing the dedicated storage area of the downstream company (step S12). This key is assigned to an account of the upstream company. When the key has been generated, the authority setting unit 112 of the server device 1 transmits a permission information input request to the company terminal 2B used by the upstream company. The permission information input request is a request for the upstream company to input permission information (i.e., invest authority to access the product information).

The operator of the upstream company that has received the input request identifies the product that the company that has transmitted the disclosure request may be authorized to access, and inputs permission information via the company terminal 2B (step S13). In this step, the company terminal 2B may provide the user interface screen described with reference to FIG. 9A to designate a combination of any product and the downstream company permitted to access the product information. The input permission information is transmitted to the server device 1.

In step S14, the authority setting unit 112 of the server device 1 invests authority to access the target product information based on the received permission information. In this step, as described with reference to FIG. 11, the authority setting unit 112 writes (copies) the target product information in the dedicated storage area of the downstream company by using the key issued to the account of the upstream company. Thus, the authority to access any product information can be invested in any company.

Additional information may be assigned when copying the product information in this step. For example, the product information generated by the upstream company may include a product number. Since the product number is used by the upstream company, it may not be used by the downstream company as it is. For example, a product number to be used by the downstream company may be added to the copy target product information as the additional information.

In step S15, the linking request unit 213 of the company terminal 2A transmits data for requesting the server device 1 to link the product information transmitted to the server device 1 to the upstream product (linking request). The linking request includes a company ID of the company and a product ID of the target product.

In step S16, the server device 1 (linking unit 113) generates a list of products that the target company is permitted to access, and provides the company terminal 2A with a user interface screen including the list. The list of products that the target company is permitted to access can be extracted from the pieces of product information that the company is authorized to access. In this step, the server device 1 may provide the company terminal 2A with the user interface screen described with reference to FIG. 10 to designate a combination of any product and the upstream product to be linked to the product.

In step S17, the linking request unit 213 of the company terminal 2A receives, from the operator, designation of a combination of the target product and the upstream product to be linked to the target product. The linking request unit 213 generates data indicating association between the upstream product and the downstream product (linking data), and transmits the generated linking data to the server device 1.

In step S18, the linking unit 113 of the server device 1 updates the stored pieces of product information based on the linking data to reflect the details of the linking between the pieces of product information. The pieces of product information may be linked by storing information (identifier, pointer, etc.) on the upstream product in the linking-related information in the product information of the downstream product.

When there is no upstream company for a certain company (when there is no linking destination for the target product), the company terminal 2 of this company may execute the process of setting the termination flag instead of transmitting the disclosure request. In this case, the process shown in FIG. 16 is omitted.

FIG. 17 is a sequence diagram corresponding to the fourth phase. In step S21, the company terminal 2 (information acquiring unit 214) first requests the server device 1 to provide information on a product tree. The request includes, for example, an identifier of the target product. The target product may be a final product or any other product (intermediate product).

The server device 1 (information providing unit 114) that has received the request determines whether the product tree is finalized (step S22). In this step, determination is made that the product tree is finalized when the following condition is satisfied.

### (Condition 1) the Termination Flags are Set to “1” for the Pieces of Product Information at all the Leaf Nodes

When the termination flags are set for all the leaf nodes, the product tree is finalized.

When even one of the leaf nodes in the product tree does not meet the above condition, further linking may occur for the target product. In this case, the server device 1 (information providing unit 114) may return the determination result to the company terminal 2 and then terminate the process.

Next, the server device 1 (information providing unit 114) generates information on the product tree through the above process (step S23). At this time, the information providing unit 114 executes the process of integrating pieces of traceability-related information defined in the pieces of product information from the most upstream side to the most downstream side. The result of the integration is reflected in each piece of product information.

In step S24, the process of concealing information without access authority is executed based on the access authority invested in the target company. For example, when the existence of product information of another company is not disclosed for a certain company, a process of concealing the existence of the product information is executed. When only a specific item in the product information is not disclosed, a process of concealing details of the item is executed. Information on the product tree subjected to the concealing process is provided to the company terminal 2 (information acquiring unit 214) and is output.

In the present embodiment described above, in the system that collects pieces of product information from the company terminals 2 and generates a product tree, designation of a downstream company permitted to access information on an in-house product is received from each company terminal 2, and pieces of product information are linked based on this designation. Access to the product information is controlled by storing the product information in a plurality of storage areas that each company is authorized to access. When providing the product tree to each company terminal 2, the information concealing process is executed within the range of the access authority of each company. With such a configuration, it is possible to collect pieces of information over the entire supply chain while maintaining confidentiality.

The server device 1 according to the present embodiment holds information indicating whether each piece of product information is the terminal end of the product tree. Thus, the server device 1 can determine whether the product tree is completed.

### Modification of First Embodiment

In the first embodiment, determination is made that the product tree is finalized when the termination flags are set to “1” for the pieces of product information at all the leaf nodes. However, further linking may occur for a product that has been linked at an intermediate node. For example, when a certain downstream product is linked to one upstream product, it may further be linked to second and subsequent upstream products.

In consideration of such a case, the determination may be made in step S22 by using the following condition in addition to condition 1.

(Condition 2) the Linking Completion Flags are Set to “1” for the Pieces of Product Information at all the Nodes Other than the Leaf Nodes
By using both conditions 1 and 2, it is possible to guarantee that the product tree is finalized.

### Second Embodiment

In the first embodiment, the server device 1 issues the key to the account of the upstream company, and uses the key to control the access (permit writing) to the dedicated storage area of the downstream company. The key may be managed, for example, by at least one of an operation system and middleware operating on the server device 1.

The control on the access to the dedicated storage area of the downstream company can be implemented by using various platforms. In a second embodiment, data is written in the dedicated storage area allocated to the downstream company by using an electronic certificate. The “key” exemplified in the first embodiment may be the electronic certificate itself, or a component of the electronic certificate (e.g., a public key). The electronic certificate may be issued by a certificate authority or by the company terminal 2 of the downstream company or the server device 1. The electronic certificate may be issued to any destination as long as a company can be identified in the supply chain.

In the first embodiment, the server device 1 issues the key to the upstream company. In the second embodiment, the server device 1 requests the certificate authority to issue the electronic certificate to be given to the upstream company. The electronic certificate may include a public key of the downstream company and an electronic signature for the public key. By receiving the electronic certificate from the downstream company, the upstream company can obtain writing authority for the dedicated storage area of the downstream company, and can verify the writing authority (e.g., the public key) based on the electronic signature.

The upstream company uses the acquired electronic certificate (key) of the downstream company to write product information on the upstream product in the dedicated storage area of the downstream company. At this time, the upstream company may encrypt the product information on the upstream product by using the public key in the electronic certificate, and write the encrypted product information in the dedicated storage area of the downstream company. The downstream company can decrypt the written information by using a private key generated in association with the public key. The “issuance of the key indicating the writing authority for the dedicated storage area to the upstream company” in the present disclosure may also include such a method. That is, the configuration of the key of the present disclosure is not particularly limited as long as it can indicate the writing authority for the target dedicated storage area. In one example, the key may be data simply indicating the writing authority. In another example, the key may be used for other roles (encryption in the second embodiment) in addition to the writing authority as in the second embodiment. In the present embodiment, the certificate authority issues the electronic certificate, but the electronic certificate may be issued by the company terminal 2 of the downstream company or by the server device 1.

Different electronic certificates may be issued to a plurality of upstream companies. In this case, the server device 1 requests the certificate authority to issue an electronic certificate in response to a request from the downstream company. At this time, the certificate authority holds the relationship between the issued electronic certificate and the upstream company to which the electronic certificate is given. The certificate authority provides data for verifying the electronic certificate only to the upstream company to which the electronic certificate is given. Thus, only the target upstream company can be permitted to verify the authenticity of the electronic certificate. The electronic certificate issuance request may be given from the company terminal 2 of the downstream company to the certificate authority or from the server device 1 to the certificate authority. When the server device 1 issues the electronic certificate, the server device 1 may manage the correspondence relationship described above.

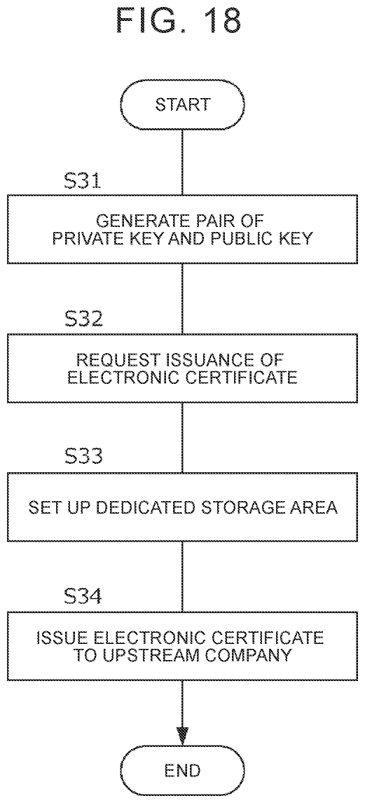

FIG. 18 is a flowchart showing an example of a flow of a process when the upstream company uses the electronic certificate to write data in the dedicated storage area allocated to the downstream company.

In step S31, a pair of a private key and a public key is first generated in association with the downstream company. The private key and the public key may be generated by the certificate authority, the company terminal 2 of the downstream company, or the server device 1.

In step S32, the certificate authority is requested to issue an electronic certificate in response to a request from the downstream company. The issuance of the electronic certificate may be requested in association with the public key generated in step S31. In this step, a request may be made to issue an electronic certificate for information other than the public key generated in step S31 (e.g., another public key). In this case, step S31 may be omitted. The electronic certificate issuance request may be transmitted from the company terminal 2 to the certificate authority or from the server device 1 that has received a request from the company terminal 2 to the certificate authority. The electronic certificate need not include the public key. In this case, any information may be designated as the target of the electronic signature.

When electronic certificates are issued to a plurality of upstream companies, an issuance destination may be designated for the certificate authority in this step. In this case, the certificate authority stores the correspondence relationship between the issued electronic certificate and the company to which it is issued.

In step S33, the downstream company sets up its dedicated storage area so that data can be exchanged by using the public key and the private key of the downstream company. For example, when each storage area is constructed by using blockchain infrastructure and the public key in the electronic certificate indicates writing authority, a smart contract may be used to set permission to write data using the public key.

In step S34, the issued electronic certificate is transmitted to the company terminal 2 associated with the upstream company. The company terminal 2 associated with the upstream company verifies the authenticity of the received electronic certificate at any timing. For example, the authenticity of the public key can be verified by decrypting the electronic signature in the electronic certificate with the public key and checking whether the obtained value agrees with a hash value of the public key. In the second embodiment, steps S33 and S34 are an example of the process of “issuing, to the upstream company, the key indicating the writing authority for the dedicated storage area of the downstream company”. The order of execution of steps S33 and S34 may be reversed.

In the present embodiment, the electronic certificate is used as the key, but data other than the electronic certificate may be used as the key. In another example, the key may be a random character string or a hash value.

### Modifications

The above embodiments are merely illustrative, and the present disclosure may be modified as appropriate without departing from the spirit and scope of the present disclosure. For example, the processes and means described in the present disclosure can be combined as desired as long as no technical contradiction occurs.

In the description of the embodiments, the server device 1 stores the product information in the database, but the product information may be stored by means other than the database.

The description of the embodiments is directed to the form in which the server device 1 completes the product tree by executing the first to fourth phases. However, the roles of the server device 1 may be distributed among a plurality of company terminals 2. For example, the product information may be stored in a distributed database using blockchain infrastructure. In this case, a plurality of company terminals 2 may construct the product information database. In this case, smart contracts may be used to execute the processes in the individual phases. For example, the process in the second phase may be executed in response to writing of permission information to the database with an account of a certain company. The process in the third phase may be executed in response to writing of a linking request to the database with an account of a certain company.

The storage areas that store the pieces of product information may be distributed among a plurality of company terminals 2. In this case, the dedicated storage area may be provided only in the company terminal 2 of the corresponding company.

The description of the embodiments is directed to the example in which the companies adjacent in the supply chain are permitted to access any product information. However, companies that are not adjacent in the supply chain may share the product information. For example, companies that do not have a direct transaction relationship may share specific product information when the companies need to share information for the purpose of legal compliance. Even in this case, necessary data can be written in a predetermined storage area by issuing a key to an account of the target company as in the first embodiment. When blockchain infrastructure is used for each storage area, the access control using the key may be executed by smart contracts.

Although the example of FIG. 16 shows the form in which the downstream company transmits the disclosure request and the upstream company transmits the permission information in response to this, the flow of the process is not limited to this. For example, the upstream company may transmit the permission information first. In this case, the server device 1 may determine whether a key has been generated based on an instruction from the downstream company, and request the downstream company to transmit the disclosure request when the key has not been generated.

In the description of the embodiments, the phase in which the server device 1 receives product information on an upstream product and the phase in which the server device 1 receives permission information associated with the product information are described separately, but both of them may be received simultaneously. In the description of the embodiments, the phase in which the server device 1 receives product information on a downstream product and the phase in which the server device 1 receives a disclosure request related to the product information are described separately, but both of them may be received simultaneously.

In the above embodiments, the companies in the supply chain are described as companies that produce products. However, the companies in the supply chain need not be the companies that produce products. For example, companies that transport, import, store, or wholesale products may also be included in the companies constituting the supply chain. In one example, some of the companies may be companies that do not execute manufacturing processes, such as trading companies, sales agents, or import agents, and may receive products from companies positioned one level higher (upstream companies) and deliver the products to companies positioned one level lower (downstream companies).

In the above embodiments, the supply chain of automotive products is assumed, the OEM is described as the most downstream company, and the companies that supply components, materials, assemblies, etc. are described as the suppliers. However, the companies belonging to the supply chain are not necessarily limited to these companies. The company in each stage may be determined as appropriate depending on the product etc. The manufacturing activities performed by the companies until the final product is obtained may be determined as appropriate depending on embodiments, and may include all activities that can be performed until the final product is obtained, such as excavation, machining, assembling, transportation, and storage.

In the description of the embodiments, the phase in which an upstream company invests a downstream company with authority to access product information based on a disclosure request transmitted from the downstream company (second phase) and the phase in which pieces of product information are linked to each other (third phase) are executed separately. However, these processes may be executed continuously.

For example, the step of transmitting the linking request may be omitted by including the linking request in the disclosure request. In one example, the disclosure request may include designation of an upstream product for which disclosure is requested. The upstream product may be designated by any method with which the upstream product can be identified, such as a product number, a product name, or a transaction record. In this case, the server device 1 may omit the processes of steps S15 to S18. In response to disclosure permission made by the upstream company in step S14, the server device 1 may automatically execute the process for linking pieces of product information identified by the disclosure request. Alternatively, the server device 1 may inquire of the account of the downstream company about the execution of the linking process in response to the disclosure permission made by the upstream company, and execute the linking process in response to a reply from the account of the downstream company. In this way, a part of the process shown in FIG. 16 can be omitted. In this modification, the linking process for the downstream company is executed based on the response from the upstream company. Therefore, the response from the upstream company may correspond to a permission response or a linking instruction to the linking request. Therefore, the disclosure request from the downstream company may be regarded as a linking request, and the permission response from the upstream company may be regarded as a linking permission or a linking instruction.

In another example, the server device 1 may notify the company terminal 2 of the downstream company about the result of the linking process that is automatically executed. Alternatively, the server device 1 may transmit a notification for requesting permission to execute the linking process to the company terminal 2 of the downstream company before the linking process is automatically executed. The server device 1 may execute the linking process based on a permission response from the company terminal 2 of the downstream company.

In the description of the embodiments, the server device 1 generates the key based on the disclosure request transmitted from the company terminal 2 of the downstream company, but the key may directly be generated by the company terminal 2 of the downstream company. In the description of the embodiments, in step S14, the authority setting unit 112 that has received the permission information writes the product information on the upstream product in the dedicated storage area of the downstream company, but the company terminal 2 of the upstream company may directly write the product information.

In the above embodiments, the company terminal 2 of the downstream company or the server device 1 may generate a key at any timing and give the generated key to the upstream company regardless of the disclosure request. In this case, step S11 (disclosure request) may be omitted.

The number of keys indicating the writing authority for the companies may be set as appropriate. In one example, the downstream company may generate a key common to all the upstream companies and provide the generated key to the upstream companies. In another example, for at least some of the upstream companies requested to disclose their product information, the downstream company may generate a key different from those for the other upstream companies.

The key may expire at any timing. In one example, the key may be valid only once. In this case, the key may be generated each time the downstream company requests the upstream company to disclose information. In another example, the generated key may be used continuously. In this case, step S12 (key generation) may be omitted as long as the generated key is used continuously.

In the description of the embodiments, it is assumed that the upstream company and the downstream company are different companies, that is, the upstream product and the downstream product are produced by different companies. In the above embodiments, the most upstream company may be the upstream company, and the most downstream company may be the downstream company. Each company other than the most upstream company and the most downstream company may be both the upstream company and the downstream company. Therefore, in the second phase, the company terminal 2 of each company may set its company (target company) as the upstream company and transmit, to the server device 1, permission information including designation of its downstream company permitted to access product information on the in-house product. The in-house product is an example of a first target product of the target company, and the product information on the in-house product is an example of first product information on the first target product. In response to this, the server device 1 may set the access authority. In the third phase, the company terminal 2 of each company may set its company as the downstream company and transmit, to the server device 1, a termination flag setting request or a linking request including selection of product information to be linked to the product information on the in-house product from among pieces of product information that the company is permitted by its upstream company to access. In this case, the in-house product is an example of a second target product of the target company, and the product information on the in-house product is an example of second product information on the second target product. In response to this, the server device 1 may process the linking or the termination flag. The first target product (target of access permission) and the second target product (target of linking or termination flag assignment) may be the same or different. When the first target product and the second target product are the same, the first product information and the second product information may be the same. When the first target product and the second target product are different, the first product information and the second product information may be different.

The above embodiments show the example of calculation of the amount of CO₂ emission (Carbon Footprint of Products (CFP) value). The CFP value may be calculated by the following calculation formula.
Tier N−1 CFP value=Tier N−1 in-house measured CFP value+Σₖ (CFP value of company k (Tier N)× use amount uk in Tier N−1)

In this formula, the “Tier N−1 CFP value” indicates a result of integrating the CFP value of the upstream company (company k (Tier N)) and the CFP value of the company of interest. The in-house measured CFP value indicates a CFP value included in the product information of each company. When Tier N is the most upstream company, a “Tier N CFP value” is a CFP value included in the product information of this company. In other cases, the “Tier N CFP value” is a result of integrating a CFP value of an upstream company (Tier N+1) and the CFP value included in the product information of the company of interest. When Tier N is set as the most upstream company (terminal end company) and the calculation is repeated until N=1, the CFP value of a Tier 0 product (=final product) can be obtained.

In the above embodiments, the server device 1 may calculate the recycling rate and the due diligence (score) together with or instead of the calculation of the amount of CO₂ emission (CFP value). The recycling rate may be calculated by the following calculation formula.

“(Recycling rate of target substance in Tier N−1 product)={(total use amount in Tier N−1)×(recycling rate in Tier N−1)+Σₖ (total use amount in company k (Tier N)×recycling rate in company k (Tier N)×use amount uₖ in Tier N−1)}÷{total use amount in Tier N−1+Σₖ (total use amount in company k (Tier N)×use amount uₖ in Tier N−1)}={recycled material use amount in Tier N−1+Σₖ (recycled material use amount in company k (Tier N)×use amount uₖ in Tier N−1)}={total use amount in Tier N−1+Σₖ (total use amount in company k (Tier N)×use amount uₖ in Tier N−1)}”

The recycled material use amount indicates an amount of the recycled material used in the target substance. Similarly to the CFP value, the recycling rate of the target substance in the final product can be calculated by sequential calculation from the most upstream company (terminal end company). The due diligence score (DD score) can be integrated by calculation similar to those for the CFP value and the recycling rate. In one example, the DD score (integration result) in the final product can be obtained by replacing the CFP value with the DD score and performing sequential calculation from the most upstream company (terminal end company).

In the above embodiments, it is assumed that each company places an order for a certain material with one company. In the above embodiments, however, the order format of each company is not limited to such an example. At least a part of the companies belonging to the supply chain may place an order for the same product with a plurality of upstream companies and use the obtained upstream products selectively for the in-house product. In the example of FIG. 13A, a product A11_1, a product A11_2, or a product A11_3 in Tier 2 may be used selectively for the product A1 in Tier 1. In this case, the server device 1 may hold the linking relationship for each pattern for use. In the above example, the server device 1 may hold pieces of linking information for the product A1 in Tier 1, such as a pattern 1 “product A11_1 in Tier 2, . . . ”, a pattern 2 “product A11_2, . . . ”, and a pattern 3 “product A11_3, . . . ”. In response to this, the server device 1 may execute the calculation (integration) of the traceability-related information for each pattern. In one example, the server device 1 may output the calculation result for each pattern. In another example, the server device 1 may calculate, based on the calculation result, statistics such as a maximum value, a minimum value, an average value, a variance, a standard deviation, and a median of the calculation result, and output the calculated statistics.

In the above embodiments, the traceability-related information (in particular, CFP value) may be composed of primary data or may be composed of secondary data (inventory data). The primary data is a measured value, and the secondary data is a reference value to be used when the measured value is not obtained. In this case, the calculation (integration) of the traceability-related information may include calculating the primary data ratio of the traceability-related information obtained for the final product. The primary data ratio may be calculated by simple ratio calculation, or by weighted calculation involving replacing the CFP value with the primary data ratio of each company in the above CFP value calculation formula and performing sequential calculation from the most upstream company.

In the above embodiments, the linking information (including the termination flag) of each company may be subjected to the transfer process and the integration process from the most upstream company to the target company (typically, the most downstream company) similarly to the traceability-related information. Therefore, the results of integration of the pieces of linking information from the most upstream company to the company of interest are written in the dedicated storage area of each company. Thus, each company can refer to the product tree up to the company. The target of application of this modification in which the linking information is subjected to the transfer process and the integration process is not limited to the access restriction configuration of the above embodiments. For example, in the storage unit 12 of the server device 1, a shared storage area may be provided between companies that share information in addition to the dedicated storage area of each company. In this case, the upstream company may share the product information on the upstream product by writing the product information in the shared storage area between the upstream company and the downstream company instead of writing the product information on the upstream product in the dedicated storage area of the downstream company by using the key received from the downstream company. That is, in this configuration, the information writing in the dedicated storage area of the downstream company using the key of the downstream company may be replaced with the information writing in the corresponding shared storage area. The configuration for executing the transfer process and the integration process on the linking information may also be applied to such an access restriction configuration.

In the above embodiments, the linking information (including the termination flag) of each company may be held by any method. In another example, a storage area shared among all the companies may be provided in the server device 1 (storage unit 12), and the linking information of each company may be held in the storage area shared among all the companies. In still another example, the dedicated storage area of each company may include a non-encrypted area, and the linking information of each company may be stored in the non-encrypted area of the dedicated storage area of each company. Alternatively, the linking information of each company may be held in an encrypted area of the dedicated storage area of each company. As long as the linking relationships of the product tree can be traced on the system, the configuration and the holding format of the linking information are not particularly limited and may be selected as appropriate depending on embodiments.

The process described as being executed by a single device may be executed by a plurality of devices in cooperation. Alternatively, the process described as being executed by different devices may be executed by a single device. In a computer system, the hardware configuration (server configuration) that implements functions can be changed flexibly.

The present disclosure may be embodied such that a computer program that implements the functions described in the above embodiments is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any types of disk or disc such as magnetic disks (e.g., a floppy (registered trademark) disk and a hard disk drive (HDD)) and optical discs (e.g., a compact disc ROM (CD-ROM), a digital versatile disc (DVD), and a Blu-ray disc), a read only memory (ROM), a random access memory (RAM), an EPROM, an electrically erasable programmable ROM (EEPROM), a magnetic card, a flash memory, an optical card, and any types of medium suitable to store electronic instructions.

What is claimed is:

1-20. (canceled)

21. A server comprising:
a memory including dedicated storage areas associated with companies, and configured to store, for each of the companies in a supply chain, pieces of product information on products of the companies by storing the pieces of product information of the companies in the associated dedicated storage areas, the supply chain including an upstream company and a downstream company defined between companies in a pair of adjacent tiers; and
one or more processors configured to execute, between the companies in the pair of adjacent tiers:
issuing, to the upstream company, a key indicating writing authority for the dedicated storage area of the downstream company in response to a request from an account of the downstream company;
receiving designation of the downstream company from an account of the upstream company, the designation being designation for permitting to make access to pieces of first product information on upstream products of the upstream company;
writing, in response to permission for the access, the pieces of first product information in the dedicated storage area of the designated downstream company by using the key issued from the designated downstream company;
receiving, from the account of the downstream company, a linking request including selection of first product information to be linked to second product information on a downstream product of the downstream company from among the pieces of first product information written in the dedicated storage area of the downstream company; and
generating, in response to the received linking request, linking information indicating a relationship of linking designated by the linking request.

22. The server according to claim 21, wherein the supply chain has a structure of three or more tiers.

23. The server according to claim 21, wherein:
the product information includes traceability-related information; and
the one or more processors are configured to further execute:
acquiring pieces of traceability-related information included in product information of one or more incorporated products included in a target product and product information of the target product, the one or more incorporated products being identified from linking information related to the target product;
integrating the pieces of traceability-related information acquired for the one or more incorporated products and the target product; and
outputting a result of the integrating.

24. The server according to claim 23, wherein:
the traceability-related information includes information on an amount of greenhouse gas emission; and
the integrating of the pieces of traceability-related information includes calculating a total amount of greenhouse gas emission related to manufacturing activities until the target product is manufactured by integrating amounts of greenhouse gas emission for the one or more incorporated products and the target product.

25. The server according to claim 23, wherein:
the traceability-related information includes a recycling rate related to a predetermined raw material; and
the integrating of the pieces of traceability-related information includes calculating an overall recycling rate of the predetermined raw material in the target product by integrating recycling rates related to the predetermined raw material in the one or more incorporated products and the target product.

26. The server according to claim 23, wherein:
the traceability-related information includes a score related to due diligence; and
the integrating of the pieces of traceability-related information includes calculating an overall score related to due diligence for the target product by integrating scores related to due diligence for the one or more incorporated products and the target product.

27. The server according to claim 23, wherein:
the acquiring of the pieces of traceability-related information and the integrating of the pieces of traceability-related information include repeating:
transferring, in a product tree to which the target product belongs as a root node, the traceability-related information of the upstream product to the downstream product between the companies in the pair of adjacent tiers in a range from most upstream products belonging to the product tree as leaf nodes to the target product,
integrating the transferred traceability-related information of the upstream product and the traceability-related information originating from the downstream product, and
acquiring a result of the integrating as the traceability-related information of the downstream product;
the transferring of the traceability-related information of the upstream product to the downstream product includes writing the traceability-related information of the upstream product in the associated dedicated storage area of the downstream company; and
the integrating of the transferred traceability-related information of the upstream product and the traceability-related information originating from the downstream product includes integrating the traceability-related information of the upstream product and the traceability-related information originating from the downstream product that are stored in the associated dedicated storage area of the downstream company.

28. The server according to claim 27, wherein the target product is a product related to a battery.

29. An information processing method to be executed by a server including a memory configured to store, for individual companies in a supply chain, pieces of product information on products of the companies, and one or more processors, the information processing method comprising:
between companies in a pair of adjacent tiers,
issuing, to an upstream company, a key indicating writing authority for a dedicated storage area of a downstream company in response to a request from an account of the downstream company, the supply chain including the upstream company and the downstream company defined between the companies in the pair of adjacent tiers, the memory including dedicated storage areas associated with the companies, the pieces of product information of the companies being stored in the associated dedicated storage areas;
receiving designation of the downstream company, from an account of the upstream company, the designation being designation for permitting to make access to pieces of first product information on upstream products of the upstream company;
writing, in response to permission for the access, the pieces of first product information in the dedicated storage area of the designated downstream company by using the key issued from the designated downstream company;
receiving, from the account of the downstream company, a linking request including selection of first product information to be linked to second product information on a downstream product of the downstream company from among the pieces of first product information written in the dedicated storage area of the downstream company; and
generating, in response to the received linking request, linking information indicating a relationship of linking designated by the linking request.

30. The information processing method according to claim 29, wherein the supply chain has a structure of three or more tiers.

31. The information processing method according to claim 29, wherein:
the product information includes traceability-related information; and
the information processing method further includes:
acquiring pieces of traceability-related information included in product information of one or more incorporated products included in a target product and product information of the target product, the one or more incorporated products being identified from linking information related to the target product;
integrating the pieces of traceability-related information acquired for the one or more incorporated products and the target product; and
outputting a result of the integrating.

32. The information processing method according to claim 31, wherein:
the traceability-related information includes information on an amount of greenhouse gas emission; and
the integrating of the pieces of traceability-related information includes calculating calculate a total amount of greenhouse gas emission related to manufacturing activities until the target product is manufactured by integrating amounts of greenhouse gas emission for the one or more incorporated products and the target product.

33. The information processing method according to claim 31, wherein:
the traceability-related information includes a recycling rate related to a predetermined raw material; and
the integrating of the pieces of traceability-related information includes calculating an overall recycling rate of the predetermined raw material in the target product by integrating recycling rates related to the predetermined raw material in the one or more incorporated products and the target product.

34. The information processing method according to claim 31, wherein:
the traceability-related information includes a score related to due diligence; and
the integrating of the pieces of traceability-related information includes calculating calculate an overall score related to due diligence for the target product by integrating scores related to due diligence for the one or more incorporated products and the target product.

35. The information processing method according to claim 31, wherein:
the acquiring of the pieces of traceability-related information and the integrating of the pieces of traceability-related information include repeating:
transferring, in a product tree to which the target product belongs as a root node, the traceability-related information of the upstream product to the downstream product between the companies in the pair of adjacent tiers in a range from most upstream products belonging to the product tree as leaf nodes to the target product,
integrating the transferred traceability-related information of the upstream product and the traceability-related information originating from the downstream product, and
acquiring a result of the integrating as the traceability-related information of the downstream product;
the transferring of the traceability-related information of the upstream product to the downstream product includes writing the traceability-related information of the upstream product in the associated dedicated storage area of the downstream company; and
the integrating of the transferred traceability-related information of the upstream product and the traceability-related information originating from the downstream product includes integrating the traceability-related information of the upstream product and the traceability-related information originating from the downstream product that are stored in the associated dedicated storage area of the downstream company.

36. The information processing method according to claim 35, wherein the target product is a product related to a battery.

37. A non-transitory storage medium storing instructions that are executable by one or more processors in an information processing device of a target company that is configured to communicate with a server and that cause the one or more processors to perform functions comprising:
issuing, to an upstream company for the target company, a first key indicating writing authority for a dedicated storage area of the target company assuming that the target company serves as a downstream company, or transmitting, to the server, a request to issue the first key to the upstream company for the target company, the server including a memory configured to store, for individual companies in a supply chain, pieces of product information on products of the companies, the supply chain including the upstream company and the downstream company defined between companies in a pair of adjacent tiers, the memory including dedicated storage areas associated with the companies;
receiving designation of the downstream company for the target company that is permitted to make access to pieces of first product information on first target products of the target company assuming that the target company serves as the upstream company; and
writing, in response to reception of the designation, the pieces of first product information in the dedicated storage area of the designated downstream company by using a second key issued from the designated downstream company, or causing the server to write the pieces of first product information in the dedicated storage area of the designated downstream company.

38. The non-transitory storage medium according to claim 37, wherein the functions further include causing the server, by transmitting a linking request to the server, to generate linking information indicating a relationship of linking designated by the linking request, the linking request including selection of product information to be linked to second product information on a second target product of the target company assuming that the target company serves as the downstream company, from among pieces of product information written in the dedicated storage area of the target company from the upstream company for the target company.

39. The non-transitory storage medium according to claim 37, wherein the product information includes traceability-related information.

40. The non-transitory storage medium according to claim 37, wherein the product is a product related to a battery.
